(19) United States
(12) Patent Application Publication
(10) Pub. No.: US 2026/0214612 A1
(43) Pub. Date: Jul. 23, 2026

(54) USER EQUIPMENT (UE), ACCESS AND MOBILITY MANAGEMENT FUNCTION (AMF), AND COMMUNICATION CONTROL METHOD

(71) Applicant: SHARP KABUSHIKI KAISHA, Sakai City, Osaka (JP)

(72) Inventors: Masaki IZUMI, Sakai City, Osaka (JP); YASUO SUGAWARA, Sakai City, Osaka (JP)

(21) Appl. No.: 19/143,132

(22) PCT Filed: Nov. 30, 2023
(86) PCT No.: PCT/JP2023/042878

§ 371 Date: Jun. 25, 2025

(30) Foreign Application Priority Data
Dec. 28, 2022 (JP) 2022-211013

(51) Int. Cl. H04W 60/04; H04W 36/08

(52) U.S. Cl. CPC H04W 60/04; H04W 36/08

(57) ABSTRACT

A User Equipment (UE) receives a registration accept message including first identification information from a network in a registration procedure for onboarding services in an SNPN. The first identification information is a list of equivalent SNPNs. Subsequently, the UE deletes the list of equivalent SNPNs stored in the UE.

### TECHNICAL FIELD

The present example relates to a User Equipment (UE), an Access and Mobility Management Function (AMF), and a communication control method. This application claims priority based on JP 2022-211013 filed in Japan on Dec. 28, 2022, the contents of which are incorporated herein by reference.

### BACKGROUND ART

In the 3rd Generation Partnership Project (3GPP), system architecture of a 5G System (5GS), which is a fifth generation (5G) mobile communication system, has been studied, and discussions are underway to support new procedures and new functions (see NPLs 1 to 4). In recent years, active discussions are being carried out on a function for implementing localized services in a Non-Public Network (NPN) (see NPL 5).

### CITATION LIST

### Non Patent Literature

NPL 1: 3GPP TS 23.501 V18.0.0 (2022 December); 3rd Generation Partnership Project; Technical Specification Group Services and System Aspects; System architecture for the 5G System (5GS); Stage 2 (Release 18)
NPL 2: 3GPP TS 23.502 V18.0.0 (2022 December); 3rd Generation Partnership Project; Technical Specification Group Services and System Aspects; Procedures for the 5G System (5GS); Stage 2 (Release 18)
NPL 3: 3GPP TS 24.501 V18.0.1 (2022 September); 3rd Generation Partnership Project; Technical Specification Group Core Network and Terminals; Non-Access-Stratum (NAS) protocol for 5G System (5GS); Stage 3 (Release 18)
NPL 4: 3GPP TS 23.122 V18.0.0 (2022 September); 3rd Generation Partnership Project; Technical Specification Group Core Network and Terminals; Non-Access-Stratum (NAS) functions related to Mobile Station (MS) in idle mode (Release 18)
NPL 5: 3GPP TR 23.700-08 V1.4.0 (2022 November); 3rd Generation Partnership Project; Technical Specification Group Services and System Aspects; Study on enhanced support of Non-Public Networks; Phase 2 (Release 18)

### SUMMARY OF INVENTION

### Technical Problem

For the 5G System (5GS), a 5G Core Network (5GCN) which is a new core network has been studied for the purpose of providing various services. Note that provision of a private network that specific users can use for specific purposes such as a Non-Public Network (NPN) defined separately from a Public Land Mobile Network (PLMN) which is a public network and functions for realizing a private network have also been studied in the 5GS.

At present, behavior of each apparatus related to an equivalent SNPN has been under study. Meanwhile, how the UE handles the equivalent SNPN in each procedure such as network selection and a registration procedure has not been clarified. For example, in a case that the registration procedure is a registration procedure for onboarding, how the UE handles the equivalent SNPN has not been clarified. Furthermore, for example, in the registration procedure, in a case that the UE is rejected from a network, how the equivalent SNPN is handled has not been clarified.

The present example is made in view of such circumstances as described above. The object thereof is to clarify behavior of a UE for an equivalent SNPN in each procedure such as network selection and a registration procedure.

### Solution to Problem

A User Equipment (UE) of the present example includes a transmission and/or reception unit, a controller, and a storage unit. The transmission and/or reception unit receives a registration accept message including first identification information from a network in a registration procedure for onboarding services in an SNPN. The first identification information is a list of equivalent SNPNs. The controller deletes the list of equivalent SNPNs stored in the storage unit.

### Advantageous Effects of Invention

According to the present example, behavior of a UE for an equivalent SNPN in each procedure such as network selection and a registration procedure can be clarified.

### BRIEF DESCRIPTION OF DRAWINGS

FIG. 1 is a diagram illustrating an overview of a mobile communication system (EPS/5GS).

FIG. 2 is a diagram illustrating a detailed configuration of the mobile communication system (EPS/5GS).

FIG. 3 is a diagram illustrating an apparatus configuration of a UE.

FIG. 4 is a diagram illustrating a configuration of an access network apparatus (gNB) in the 5GS.

FIG. 5 is a diagram illustrating a configuration of a core network apparatus (AMF/SMF/UPF) in the 5GS.

FIG. 6 is a diagram illustrating a registration procedure.

### DESCRIPTION OF EMBODIMENTS

Preferred embodiments for carrying out the present example will be described below with reference to the drawings. Note that an embodiment of a mobile communication system to which the present example is applied will be described as an example in the present embodiment.

### 1. Overview of System

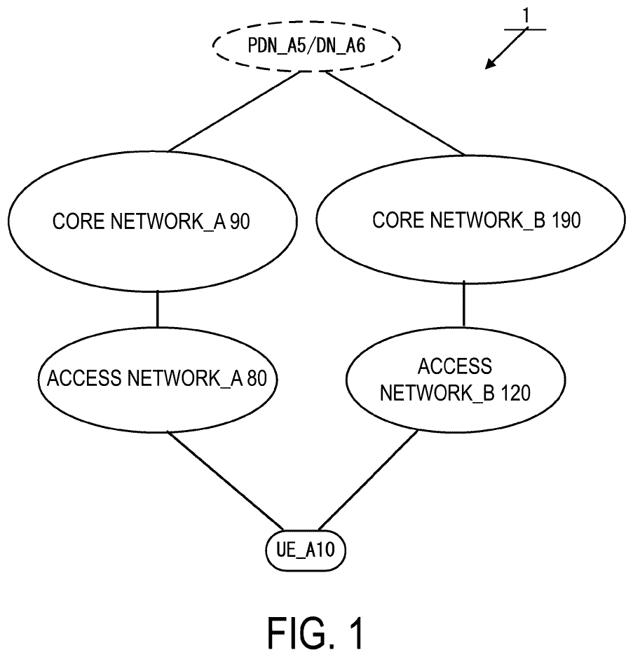

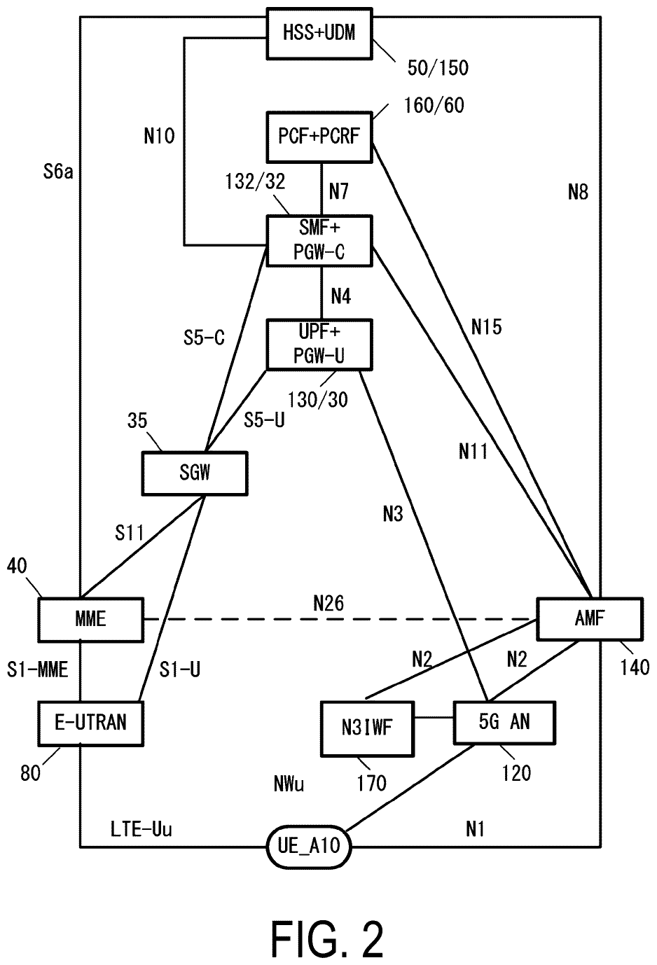

First, FIG. 1 is a diagram illustrating an overview of a mobile communication system 1 used in each embodiment, and FIG. 2 is a diagram illustrating a detailed configuration of the mobile communication system 1.

FIG. 1 illustrates the mobile communication system 1 including a UE_A 10, an access network_A 80, a core network_A 90, a Packet Data Network (PDN)_A 5, an access network_B 120, a core network_B 190, and a Data Network (DN)_A 6.

In the following description, the reference numerals of these apparatuses and functions may be omitted, as in a UE, an access network_A, a core network_A, a PDN, an access network_B, a core network_B, a DN, and the like.

In addition, FIG. 2 illustrates apparatuses and functions such as the UE_A 10, an E-UTRAN 80, an MME 40, an SGW 35, a PGW-U 30, a PGW-C 32, a PCRF 60, an HSS 50, a 5G AN 120, an AMF 140, a UPF 130, an SMF 132, a PCF 160, a UDM 150, and an N3IWF 170, and interfaces for connecting these apparatuses and functions to each other.

In the following description, the reference numerals of these apparatuses and functions may be omitted as in a UE, an E-UTRAN, an MME, an SGW, a PGW-U, a PGW-C, a PCRF, an HSS, a 5G AN, an AMF, a UPF, an SMF, a PCF, a UDM, an N3IWF, and the like.

Note that an Evolved Packet System (EPS) that is a 4G system includes an access network_A and a core network_A and may further include a UE and/or a PDN. In addition, a 5G System (5GS) that is a 5G system includes UE, an access network_B, and a core network_B and may further include a DN.

The UE is an apparatus that can be connected to a network service over 3GPP access (also referred to as a 3GPP access network or a 3GPP AN) and/or non-3GPP access (also referred to as a non-3GPP access network or a non-3GPP AN). The UE may be a terminal apparatus capable of performing radio communication, such as a mobile phone or a smartphone, and may be a terminal apparatus that can be connected to both the EPS and the 5GS. The UE may include a Universal Integrated Circuit Card (UICC) and an Embedded UICC (eUICC). Note that the UE may be referred to as user equipment or a terminal apparatus.

In addition, the access network_A corresponds to an Evolved Universal Terrestrial Radio Access Network (E-UTRAN) and/or a wireless LAN access network. In the E-UTRAN, one or more evolved Node Bs (eNBs) 45 are deployed. Note that, in the following description, the reference numeral of the eNB 45 may be omitted as in eNB. In addition, in a case that there are multiple eNBs, the eNBs are connected to each other via, for example, an X2 interface. In addition, one or more access points are deployed on the wireless LAN access network.

In addition, the access network_B corresponds to a 5G access network (5G AN). The 5G AN includes an NG Radio Access Network (NG-RAN) and/or a non-3GPP access network. One or multiple NR NodeBs (gNBs) 122 are deployed on the NG-RAN. Note that in the following description, the symbol for the gNB 122 may be omitted as a gNB. The gNB is a node that provides a New Radio (NR) user plane and control plane to the UE, and is connected to a 5GCN via an NG interface (including an N2 interface or an N3 interface). In other words, the gNB is a base station apparatus newly designed for the 5GS and has functions different from those of the base station apparatus (eNB) used in the EPS that is a 4G system. In addition, in a case that there are multiple gNBs, the gNBs are connected to each other via, for example, an Xn interface.

In addition, a non-3GPP access network may be an untrusted non-3GPP access network or a trusted non-3GPP access network. Here, the untrusted non-3GPP access network may be a non-3GPP access network that does not manage security on the access network, for example, a public wireless LAN. On the other hand, the trusted non-3GPP access network may be an access network defined by 3GPP and may include a trusted non-3GPP access point (TNAP) and a trusted non-3GPP Gateway function (TNGF).

In addition, in the following description, the E-UTRAN and the NG-RAN may be referred to as 3GPP access. In addition, the wireless LAN access network and the non-3GPP AN may be referred to as non-3GPP access. In addition, nodes deployed on the access network_B may also be collectively referred to as NG-RAN nodes.

In addition, in the following description, the access network_A, and/or the access network_B, and/or an apparatus included in the access network_A, and/or an apparatus included in the access network_B may be referred to as an access network or an access network apparatus.

The core network_A corresponds to an Evolved Packet Core (EPC). In the EPC, for example, a Mobility Management Entity (MME), a Serving Gateway (SGW), a Packet Data Network Gateway (PGW)-U, a PGW-C, a Policy and Charging Rules Function (PCRF), a Home Subscriber Server (HSS), and the like are deployed.

In addition, the core network_B corresponds to a 5G Core Network (5GCN). An Access and Mobility Management Function (AMF), a User Plane Function (UPF), a Session Management Function (SMF), a Policy Control Function (PCF), a Unified Data Management (UDM), and the like are deployed on the 5GCN. Here, the 5GCN may be referred to as a 5GC.

In addition, in the following description, the core network_A, and/or the core network_B, an apparatus included in the core network_A, and/or an apparatus included in the core network_B may be referred to as a core network, a core network apparatus, or an intra-core network apparatus.

The core network (the core network_A and/or the core network_B) may refer to an IP mobile communication network operated by a mobile communication (Mobile Network Operator (MNO)) connecting the access network (the access network_A and/or the access network_B) and the PDN and/or the DN, a core network for a mobile communication operator that operates and manages the mobile communication system 1, or a core network for a virtual mobile communication operator and a virtual mobile communication service provider such as a Mobile Virtual Network Operator (MVNO) and a Mobile Virtual Network Enabler (MVNE).

In addition, although FIG. 1 illustrates a case that the PDN and the DN are the same, the PDN and the DN may be different. The PDN may be a Data Network (DN) that provides communication services to the UE. Note that the DN may be configured as a packet data service network or may be configured for each service. In addition, the PDN may include a connected communication terminal. Thus, “to be connected to the PDN” may mean “to be connected to a communication terminal and a server apparatus deployed in the PDN”. In addition, “to transmit and/or receive user data to and/or from the PDN” may mean “to transmit and/or receive user data to and/or from a communication terminal and a server apparatus deployed in the PDN”. Note that the PDN may be referred to as a DN, and the DN may be referred to as a PDN.

In addition, in the following, at least some of the access network_A, the core network_A, the PDN, the access network_B, the core network_B, and the DN, and/or one or more apparatuses included in these may be referred to as a network or a network apparatus. In other words, the expression that “the network and/or the network apparatus transmits and/or receives a message and/or performs a procedure” means that “at least some of the access network_A, the core network_A, the PDN, the access network_B, the core network_B, and the DN, and/or one or more apparatuses included in these transmit and/or receive a message and/or perform a procedure”.

In addition, the UE can be connected to the access network. In addition, the UE can be connected to the core network over the access network. Furthermore, the UE can be connected to the PDN or the DN over the access network and the core network. In other words, the UE can transmit and/or receive (communicate) user data to and/or from the PDN or the DN. In a case that user data is transmitted and/or received, not only Internet Protocol (IP) communication but also non-IP communication may be used.

Here, IP communication refers to data communication using an IP, and data is transmitted and/or received using IP packets. Each IP packet includes an IP header and a payload part. In the payload part, data transmitted and/or received by the apparatuses and functions included in the EPS and the apparatuses and functions included in the 5GS may be included. In addition, non-IP communication refers to data communication performed using no IP, in which data is transmitted and/or received in a form different from the structure of an IP packet. For example, non-IP communication may be data communication implemented through transmission and/or reception of application data to which an IP header is not added, or user data transmitted and/or received by the UE may be transmitted and/or received with another header such as a MAC header and an Ethernet (trade name) frame header added.

In addition, apparatuses which are not illustrated in FIG. 2 may be included in the access network_A, the core network_A, the access network_B, the core network_B, the PDN_A, and the DN_A. For example, the core network_A and/or the core network_B may include an Authentication Server Function (AUSF) and an Authentication, authorization, and accounting (AAA) server (AAA-S).

Here, the AUSF is a core network apparatus provided with an authentication function for 3GPP access and non-3GPP access. Specifically, the AUSF is a network function unit that receives an authentication request for 3GPP access and/or non-3GPP access from the UE and performs an authentication procedure.

The AAA server is an apparatus that is connected directly to the AUSF or indirectly to the AUSF via another network apparatus and has authentication, authorization, and billing functions. The AAA server may be a network apparatus within the core network. Note that the AAA server may not be included in the core network_A and/or the core network_B and may be included in the PLMN. In other words, the AAA server may be a core network apparatus or may be an apparatus outside the core network. For example, the AAA server may be a server apparatus within the PLMN managed by a 3rd party.

Note that, although each of the apparatuses and functions is illustrated one by one for simplicity in FIG. 2, multiple similar apparatuses and functions may be included in the mobile communication system 1. Specifically, multiple apparatuses and functions such as multiple pieces of UE_A 10, E-UTRANs 80, MMEs 40, SGWs 35, PGW-Us 30, PGW-Cs 32, PCRFs 60, HSSs 50, 5G ANs 120, AMFs 140, UPFs 130, SMFs 132, PCFs 160, and/or UDMs 150 may be included in the mobile communication system 1.

A UPF_A 235 is connected to the DN, the SMF, other UPFs and the access network. The UPF_A 235 may play roles of an anchor to intra-RAT mobility or inter-RAT mobility, Packet routing & forwarding, an Uplink Classifier (UL CL) function to support routing of multiple traffic flows for one DN, a Branching point function to support a multi-homed PDU session, QoS processing for a user plane, verification of uplink traffic, buffering of downlink packets, a function of triggering Downlink Data Notification, and the like. Furthermore, the UPF_A 235 may be a relay apparatus that transfers the user data as a gateway between the DN and the core network_B 190. Note that the UPF_A 235 may serve as a gateway for IP communication and/or non-IP communication. Furthermore, the UPF_A 235 may have a function of transferring IP communication or a function to perform conversion between non-IP communication and IP communication. Furthermore, the multiple gateways deployed may serve as gateways for connecting the core network_B 190 with a single DN. Note that the UPF_A 235 may have connectivity with another NF or may be connected to each apparatus via another NF.

Note that, a UPF_C 239 (also referred to as a branching point or an uplink classifier), which is a UPF different from the UPF_A 235, may be present as an apparatus or NF between the UPF_A 235 and the access network. With the UPF_C 239 present, the PDU session between the UE and the DN is established via the access network, the UPF_C 239, and the UPF_A 235.

The UPF 130 may be an apparatus similar to the UPF_A 235. Note that the UPF 130 and the UPF_A 235 may be described with the symbols thereof omitted, like the UPF.

### 2. Configuration of Each Apparatus

Next, a configuration of each apparatus (the UE, and/or the access network apparatus, and/or the core network apparatus) used in each embodiment will be described with reference to the drawings. Note that each apparatus may be configured as physical hardware, may be configured as logical (virtual) hardware configured in general-purpose hardware, or may be configured as software. In addition, at least a part (including all) of the functions of each apparatus may be configured as physical hardware, logical hardware, or software.

Note that each storage unit (a storage unit_A 340, a storage unit_A 440, a storage unit_B 540, a storage unit_A 640, and a storage unit_B 740) in each apparatus and function to be described later includes, for example, a semiconductor memory, a Solid State Drive (SSD), a Hard Disk Drive (HDD), or the like. In addition, each storage unit can store not only information originally configured at the time of being shipped, but also various pieces of information transmitted and/or received to and/or from apparatuses and functions (for example, the UE, and/or the access network apparatus, and/or the core network apparatus, and/or the PDN, and/or the DN) other than the apparatus and functions of each storage unit. In addition, each storage unit can store identification information, control information, flags, parameters, and the like included in a control message transmitted and/or received in various communication procedures to be described later. In addition, each storage unit may store these pieces of information for each UE. In addition, in a case that each storage unit performs interworking between the 5GS and the EPS, each storage unit can store a control message and user data transmitted and/or received to and/or from the apparatuses and functions included in the 5GS and/or the EPS. In this case, not only data transmitted and/or received over the N26 interface but also data transmitted and/or received without using the N26 interface can be stored.

### 2.1. Apparatus Configuration of UE

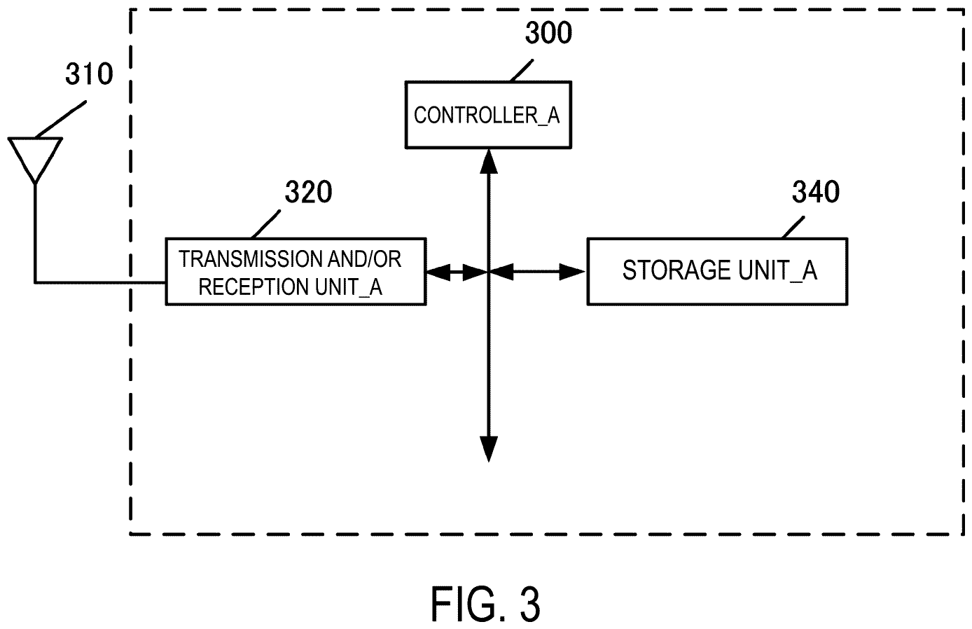

First, an apparatus configuration example of the User Equipment (UE) will be described with reference to FIG. 3. The UE includes a controller_A 300, an antenna 310, a transmission and/or reception unit_A 320, and a storage unit_A 340. The controller_A 300, the transmission and/or reception unit_A 320, and the storage unit_A 340 are connected via a bus. The transmission and/or reception unit_A 320 is connected to the antenna 310.

The controller_A 300 is a function unit that controls overall operations and functions of the UE. The controller_A 300 reads and performs various programs stored in the storage unit_A 340 as necessary, and thereby implements various types of processing in the UE.

The transmission and/or reception unit_A 320 is a function unit that performs radio communication with a base station apparatus (the eNB or the gNB) within the access network via the antenna. In other words, with the use of the transmission and/or reception unit_A 320, the UE can transmit and/or receive user data and/or control information to and/or from the access network apparatus, and/or the core network apparatus, and/or the PDN, and/or the DN.

To provide detailed description with reference to FIG. 2, by using the transmission and/or reception unit_A 320, the UE can communicate with the base station apparatus (eNB) within the E-UTRAN over an LTE-Uu interface. In addition, the UE can communicate with the base station apparatus (gNB) within the 5G AN with the use of the transmission and/or reception unit_A 320. In addition, the UE can transmit and/or receive a Non-Access-Stratum (NAS) message to and/or from the AMF over an N1 interface with the use of the transmission and/or reception unit_A 320. However, the N1 interface is a logical interface, and thus communication between the UE and the AMF is actually performed over the 5G AN.

The storage unit_A 340 is a function unit that stores programs, user data, control information, and the like necessary for each operation of the UE.

### 2.2. Apparatus Configuration of GNB

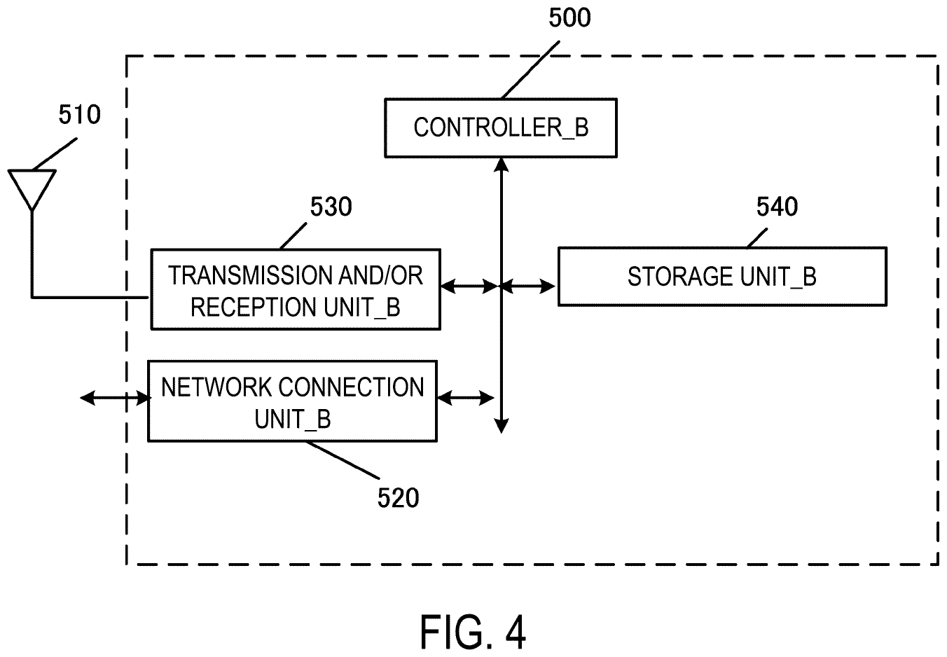

Next, an apparatus configuration example of the gNB will be described with reference to FIG. 4. The gNB includes a controller_B 500, an antenna 510, a network connection unit_B 520, a transmission and/or reception unit_B 530, and a storage unit_B 540. The controller_B 500, the network connection unit_B 520, the transmission and/or reception unit_B 530, and the storage unit_B 540 are connected via a bus. The transmission and/or reception unit_B 530 is connected to the antenna 510.

The controller_B 500 is a function unit that controls overall operations and functions of the gNB. The controller_B 500 reads and performs various programs stored in the storage unit_B 540 as necessary, and thereby implements various types of processing in the gNB.

The network connection unit_B 520 is a function unit for the gNB to communicate with the AMF and/or the UPF. In other words, with the use of the network connection unit_B 520, the gNB can transmit and/or receive user data and/or control information to and/or from the AMF and/or the UPF.

The transmission and/or reception unit_B 530 is a function unit that performs radio communication with the UE via the antenna 510. In other words, with the use of the transmission and/or reception unit_B 530, the gNB can transmit and/or receive user data and/or control information to and/or from the UE.

To provide detailed description with reference to FIG. 2, by using the network connection unit_B 520, the gNB within the 5G AN can communicate with the AMF over the N2 interface and can communicate with the UPF over the N3 interface. In addition, the gNB can communicate with the UE with the use of the transmission and/or reception unit_B 530.

The storage unit_B 540 is a function unit that stores programs, user data, control information, and the like necessary for each operation of the gNB.

### 2.3. Apparatus Configuration of AMF

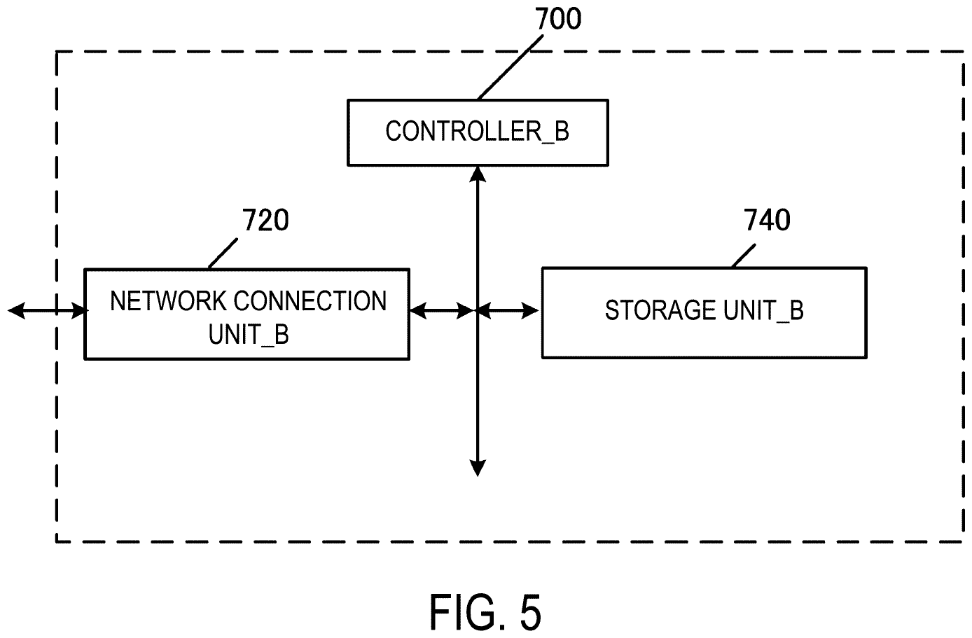

Next, an apparatus configuration example of the AMF will be described with reference to FIG. 5. The AMF includes a controller_B 700, a network connection unit_B 720, and a storage unit_B 740. The controller_B 700, the network connection unit_B 720, and the storage unit_B 740 are connected via a bus. The AMF may be a node that handles a control plane.

The controller_B 700 is a function unit that controls overall operations and functions of the AMF. The controller_B 700 reads and performs various programs stored in the storage unit_B 740 as necessary, and thereby implements various types of processing in the AMF.

The network connection unit_B 720 is a function unit for the AMF to connect to the base station apparatus (gNB) within the 5G AN, and/or the SMF, and/or the PCF, and/or the UDM, and/or an SCEF. In other words, with the use of the network connection unit_B 720, the AMF can transmit and/or receive user data and/or control information to and/or from the base station apparatus (gNB) in the 5G AN, and/or the SMF, and/or the PCF, and/or the UDM, and/or the SCEF.

To provide detailed description with reference to FIG. 2, by using a network connection unit_A 620, the AMF within the 5GCN can communicate with the gNB over the N2 interface, can communicate with the UDM over an N8 interface, can communicate with the SMF over an N11 interface, and can communicate with the PCF over an N15 interface. In addition, the AMF can transmit and/or receive a NAS message to and/or from the UE over the N1 interface with the use of the network connection unit_A 620. However, the N1 interface is a logical interface, and thus communication between the UE and the AMF is actually performed over the 5G AN. In addition, in a case that the AMF supports an N26 interface, the AMF can communicate with the MME over the N26 interface with the use of the network connection unit_A 620.

The storage unit_B 740 is a function unit that stores programs, user data, control information, and the like necessary for each operation of the AMF.

Note that the AMF has a function of exchanging a control message with the RAN using the N2 interface, a function of exchanging a NAS message with the UE using the N1 interface, a function of performing encryption and integrity protection of a NAS message, a Registration management (RM) function, a Connection management (CM) function, a Reachability management function, a Mobility management function for the UE or the like, a function of transferring a Session Management (SM) message between the UE and the SMF, an Access Authentication (Access Authorization) function, a security anchor function (Security Anchor Functionality (SEA)), a Security Context Management (SCM) function, a function of supporting the N2 interface for a Non-3GPP Interworking Function (N3IWF), a function of supporting transmission and/or reception of a NAS signal to an/or from the UE via the N3IWF, a function of authenticating the UE connected via the N3IWF, and the like.

In addition, in registration management, an RM state for each UE is managed. The RM state may be synchronized between the UE and the AMF. The RM state includes a deregistered state (RM-DEREGISTERED state) and a registered state (RM-REGISTERED state). In the RM-DEREGISTERED state, because the UE is not registered with the network, the AMF is in a state of being unable to reach the UE, because a UE context in the AMF does not have location information and routing information that are valid for the UE. In addition, in the RM-REGISTERED state, because the UE is registered in the network, the UE can receive a service that requires registration with the network. Note that the RM state may be referred to as a 5GMM state. In this case, the RM-DEREGISTERED state may be referred to as a 5GMM-DEREGISTERED state, and the RM-REGISTERED state may be referred to as a 5GMM-REGISTERED state.

In other words, 5GMM-REGISTERED may be a state in which each apparatus establishes a 5GMM context, or may be a state in which each apparatus establishes a PDU session context. Note that, in a case that each apparatus is in 5GMM-REGISTERED, the UE_A 10 may start transmission and/or reception of user data and a control message, or may respond to paging. Furthermore, note that, in a case that each apparatus is in 5GMM-REGISTERED, the UE_A 10 may perform a registration procedure other than a registration procedure for initial registration, and/or a service request procedure.

In addition, 5GMM-DEREGISTERED may be a state in which each apparatus does not establish the 5GMM context, may be a state in which the location information of the UE_A 10 is not known to the network, or may be a state in which the network is unable to reach the UE_A 10. Note that, in a case that each apparatus is in 5GMM-DEREGISTERED, the UE_A 10 may initiate the registration procedure, or may perform the registration procedure to thereby establish the 5GMM context.

In addition, in connection management, a CM state for each UE is managed. The CM state may be synchronized between the UE and the AMF. The CM state includes a non-connected state (CM-IDLE state) and a connected state (CM-CONNECTED state). In the CM-IDLE state, the UE is in the RM-REGISTERED state, but does not have NAS signaling connection established with the AMF via the N1 interface. In addition, in the CM-IDLE state, the UE has neither connection of the N2 interface (N2 connection) nor connection of the N3 interface (N3 connection). On the other hand, in the CM-CONNECTED state, the UE has NAS signaling connection established with the AMF via the N1 interface. In addition, in the CM-CONNECTED state, the UE may have connection of the N2 interface (N2 connection) and/or connection of the N3 interface (N3 connection).

Furthermore, in connection management, management may be performed separately for the CM state in 3GPP access and the CM state in non-3GPP access. In this case, the CM state in 3GPP access may include a non-connected state in 3GPP access (CM-IDLE state over 3GPP access) and a connected state in 3GPP access (CM-CONNECTED state over 3GPP access).

Furthermore, the CM state in non-3GPP access may include a non-connected state in non-3GPP access (CM-IDLE state over non-3GPP access) and a connected state in non-3GPP access (CM-CONNECTED state over non-3GPP access). Note that the non-connected state may be referred to as an idle mode, and a connected state mode may be referred to as a connected mode.

Note that the CM state may be referred to as a 5GMM mode. In this case, the non-connected state may be referred to as a 5GMM non-connected mode (5GMM-IDLE mode), and the connected state may be referred to as a 5GMM connected mode (5GMM-CONNECTED mode). In addition, the non-connected state in 3GPP access may be referred to as a 5GMM non-connected mode in 3GPP access (5GMM-IDLE mode over 3GPP access), and the connected state in 3GPP access may be referred to as a 5GMM connected mode in 3GPP access (5GMM-CONNECTED mode over 3GPP access). In addition, the non-connected state in non-3GPP access may be referred to as a 5GMM non-connected mode in non-3GPP access (5GMM-IDLE mode over non-3GPP access), and the connected state in non-3GPP access may be referred to as a 5GMM connected mode in non-3GPP access (5GMM-CONNECTED mode over non-3GPP access). Note that the 5GMM non-connected mode may be referred to as an idle mode, and the 5GMM connected mode may be referred to as a connected mode.

In addition, one or multiple AMFs may be deployed within the core network_B. The AMF may be a Network Function (NF) that manages one or more Network Slice Instances (NSIs). In addition, the AMF may be a common CP function (Common Control Plane Network Function (CPNF) (CCNF)) shared among multiple NSIs.

Note that, in a case that the UE connects to the 5GS over non-3GPP access, the N3IWF is an apparatus and/or a function deployed between non-3GPP access and the 5GCN.

### 2.4. Apparatus Configuration of SMF

Next, an apparatus configuration example of the SMF will be described with reference to FIG. 5. The SMF includes a controller_B 700, a network connection unit_B 720, and a storage unit_B 740. The controller_B 700, the network connection unit_B 720, and the storage unit_B 740 are connected via a bus. The SMF may be a node that handles the control plane.

The controller_B 700 is a function unit that controls overall operations and functions of the SMF. The controller_B 700 reads and performs various programs stored in the storage unit_B 740 as necessary, and thereby implements various types of processing in the SMF.

The network connection unit_B 720 is a function unit for the SMF to connect to the AMF, and/or the UPF, and/or the PCF, and/or the UDM. In other words, with the use of the network connection unit_B 720, the SMF can transmit and/or receive user data and/or control information to and/or from the AMF, and/or the UPF, and/or the PCF, and/or the UDM.

To provide detailed description with reference to FIG. 2, by using of the network connection unit_A 620, the SMF in the 5GCN can communicate with the AMF over the N11 interface, can communicate with the UPF over the N4 interface, can communicate with the PCF over an N7 interface, and can communicate with the UDM over an N10 interface.

The storage unit_B 740 is a function unit that stores programs, user data, control information, and the like necessary for each operation of the SMF.

The SMF has a Session Management function for managing establishment, modification, and release of a PDU session, a function of IP address allocation to the UE and management thereof, a function of selection and control of the UPF, a function of configuring the UPF for routing traffic to an appropriate destination (transmission destination), a function of transmitting and/or receiving an SM part of a NAS message, a function of providing notification of arrival of downlink data (Downlink Data Notification), a function of providing SM information specific to an AN (for each AN) that is transmitted to the AN through the AMF over the N2 interface, a function of determining a Session and Service Continuity mode (SSC mode) for a session, a roaming function, and the like.

### 2.5. Apparatus Configuration of UPF

Next, an apparatus configuration example of the UPF will be described with reference to FIG. 5. The UPF includes a controller_B 700, a network connection unit_B 720, and a storage unit_B 740. The controller_B 700, the network connection unit_B 720, and the storage unit_B 740 are connected via a bus. The UPF may be a node that handles the control plane.

The controller_B 700 is a function unit that controls overall operations and functions of the UPF. The controller_B 700 reads and performs various programs stored in the storage unit_B 740 as necessary, and thereby implements various types of processing in the UPF.

The network connection unit_B 720 is a function unit for the UPF to connect to the base station apparatus (gNB) within the 5G AN, and/or the SMF, and/or the DN. In other words, with the use of the network connection unit_B 720, the UPF can transmit and/or receive user data and/or control information to and/or from the base station apparatus (gNB) within the 5G AN, and/or the SMF, and/or the DN.

To provide detailed description with reference to FIG. 2, by using the network connection unit_A 620, the UPF within the 5GCN can communicate with the gNB over the N3 interface, can communicate with the SMF over the N4 interface, can communicate with the DN over an N6 interface, and can communicate with another UPF over an N9 interface.

The storage unit_B 740 is a function unit that stores programs, user data, control information, and the like necessary for each operation of the UPF.

The UPF has a function as an anchor point for intra-RAT mobility or inter-RAT mobility, a function as an external PDU session point to be interconnected with the DN (that is, a function of transferring user data as a gateway between the DN and the core network_B), a function of routing and transferring packets, an Uplink Classifier (UL CL) function of supporting routing of multiple traffic flows for one DN, a Branching point function of supporting a multi-homed PDU session, a Quality of Service (QOS) processing function for the user plane, a function of verifying uplink traffic, a function of triggering buffering of downlink packets and Downlink Data Notification, and the like.

In addition, the UPF may be a gateway for IP communication and/or non-IP communication. In addition, the UPF may have a function of transferring IP communication, or a function of conversion between non-IP communication and IP communication. Furthermore, multiple deployed gateways may be gateways for connecting the core network_B and a single DN. Note that the UPF may have connectivity with another NF, and may be connected to each apparatus via another NF.

Note that a user plane refers to user data that is transmitted and/or received between the UE and a network. The user plane may be transmitted and/or received using a PDN connection or a PDU session. Furthermore, in a case of the EPS, the user plane may be transmitted and/or received using an LTE-Uu interface, and/or an S1-U interface, and/or an S5 interface, and/or an S8 interface, and/or an SGi interface. Furthermore, in a case of the 5GS, the user plane may be transmitted and/or received over the interface between the UE and the NG RAN, and/or the N3 interface, and/or the N9 interface, and/or the N6 interface. The user plane may be hereinafter referred to as a U-Plane.

In addition, a control plane refers to a control message that is transmitted and/or received in order to perform communication control of the UE or the like. The control plane may be transmitted and/or received using Non-Access-Stratum (NAS) signaling connection between the UE and the MME. In addition, in a case of the EPS, the control plane may be transmitted and/or received using the LTE-Uu interface and an S1-MME interface. Furthermore, in a case of the 5GS, the control plane may be transmitted and/or received using the interface between the UE and the NG RAN and the N2 interface. The control plane may be hereinafter referred to as a control plane, or may be hereinafter referred to as a C-Plane.

Furthermore, the U-Plane (User Plane (UP)) may be a communication path for transmitting and/or receiving user data, and may include multiple bearers. Furthermore, the C-Plane (Control Plane (CP)) may be a communication path for transmitting and/or receiving a control message, and may include multiple bearers.

### 2.6. Description of Other Apparatuses and/or Functions

Next, other apparatuses and/or functions will be described.

First, a network refers to at least some of the access network_B, the core network_B, and the DN. One or multiple apparatuses included in at least a part of the access network_B, the core network_B, and the DN may be referred to as a network or a network apparatus. In other words, “a network transmits and/or receives a message and/or performs processing” may mean “an apparatus (a network apparatus and/or a control apparatus) in the network transmits and/or receives the message and/or performs the processing”. Conversely, “an apparatus in a network transmits and/or receives a message and/or performs processing” may mean “the network transmits and/or receives the message and/or performs the processing”. The network may be referred to as a NW.

Furthermore, the network may indicate a Public Land Mobile Network (PLMN), or may indicate a Non-Public Network (NPN) to be described later. Furthermore, network selection may indicate PLMN selection, or may indicate SNPN selection.

Next, a Network Data Analytics Function (NWDAF) may be an NF having a function of performing data collection from an NF and an application function (also referred to as an AF).

Next, a Policy Control Function (PCF) may be an NF having a function of determining a policy for controlling a behavior of a network.

Next, a Network Repository Function (NRF) may be an NF having a service discovery function. The NRF may be an NF that, in a case of receiving a discovery request of another NF from a certain NF, provides information of the discovered NF.

Next, the Unified Data Management (UDM) may be an NF that includes an Authentication credential processing function, a user identification processing function, an access authentication function, a registration/mobility management function, a subscriber information management (subscription management) function, and the like.

Next, the Session Management (SM) message may be a NAS message used in a procedure for SM. The SM message may be referred to as a Non-Access-Stratum (NAS) SM message. The SM message may be a control message transmitted and/or received between the UE_A 10 and an SMF_A 230 via an AMF_A 240. Furthermore, the SM message may include a PDU session establishment request message, a PDU session establishment accept message, a PDU session reject message (PDU session establishment reject message), a PDU session modification request message, a PDU session modification command message, a PDU session modification completion message (PDU session modification complete), a PDU session modification command reject message, a PDU session modification reject message, a PDU session release request message, a PDU session release reject message, a PDU session release command message, a PDU session release complete message, and the like.

Next, an SM procedure (also referred to as a procedure for SM) may include a PDU session establishment procedure, a PDU session modification procedure, and a PDU session release procedure (UE-requested PDU session release procedure). Note that each procedure may be a procedure initiated by the UE, or may be a procedure initiated by the network.

Next, the Mobility management (MM) message may be a NAS message used in a procedure for MM. The MM message may be referred to as a NAS MM message. The MM message may be a control message transmitted and/or received between the UE_A 10 and the AMF_A 240. Furthermore, the MM message may include a Registration request message, a Registration accept message, a Registration reject message, a De-registration request message, a De-registration accept message, a configuration update command message, a configuration update complete message, a Service request message, a Service accept message, a Service reject message, a Notification message, a Notification response message, and the like.

Next, an MM procedure (also referred to as a procedure for MM) may include a Registration procedure, a De-registration procedure, a Generic UE configuration update procedure, an authentication and/or authorization procedure, a Service request procedure, a Paging procedure, and a Notification procedure. Note that each procedure may be a procedure initiated by the UE, or may be a procedure initiated by the network.

Next, a 5G System (5GS) service may be a connection service provided using the core network_B 190. In addition, the 5GS service may be a service different from an EPS service, or may be a service similar to the EPS service.

Next, a non 5GS service may be a service other than the 5GS service and may include an EPS service and/or a non EPS service.

Next, the S1 mode is a mode in which the UE_A 10 is allowed to access the EPC via the E-UTRAN. In other words, the S1 mode may be a mode in which a message is transmitted and/or received using an S1 interface. Note that the S1 interface may include an S1-MME interface and an S1-U interface.

Next, the N1 mode is a mode in which the UE_A 10 is allowed to access the 5GC via the 5G access network. In other words, the N1 mode may be a mode in which a message is transmitted and/or received using an N1 interface.

Next, an Access Point Name (APN) may be identification information for identifying the core network and/or an external network such as the PDN. Furthermore, the APN can also be used as information for selecting a gateway such as a PGW_A 30/UPF_A 235 for connecting to the core network_A 90.

Next, a Packet Data Network (PDN) type indicates a type of PDN connection and includes IPv4, IPv6, IPv4 v6, and non-IP. In a case that IPv4 is specified, it indicates that transmission and/or reception of data is performed using IPv4. In a case that IPv6 is specified, it indicates that transmission and/or reception of data is performed using IPv6. In a case that IPv4 v6 is specified, it indicates that transmission and/or reception of data is performed using IPv4 or IPv6. In a case that non-IP is specified, it indicates that communication is performed using a communication method other than the IP, not communication using the IP.

Next, although a Protocol Data Unit (PDU) session can be defined as a relationship between the DN that provides a PDU connectivity service and the UE, the PDU session may be connectivity established between the UE and an external gateway. In the 5GS, the UE establishes a PDU session via the access network_B and the core network_B, and can thereby perform transmission and/or reception of user data to and/or from the DN by using the PDU session.

Here, the external gateway may be a UPF, an SCEF, or the like. The UE can perform transmission and/or reception of user data to and/or from an apparatus deployed in the DN, such as an application server, by using the PDU session. Note that each apparatus (the UE, and/or the access network apparatus, and/or the core network apparatus) may associate one or multiple pieces of identification information with a PDU session for management. Note that these pieces of identification information may include one or multiple of a DNN, a QoS rule, a PDU session type, application identification information, NSI identification information, access network identification information, and an SSC mode, and may further include other pieces of information. In addition, in a case that multiple PDU sessions are established, pieces of identification information associated with the PDU sessions may have the same or different details.

Next, the Data Network Name (DNN) may be identification information for identifying the core network and/or an external network such as the DN. Further, the DNN can also be used as information for selecting a gateway such as a PGW/UPF connecting the core network_B 190. In addition, the DNN may correspond to an Access Point Name (APN).

Next, a Protocol Data Unit (PDU) session type indicates a type of PDU session and includes IPv4, IPv6, Ethernet, and Unstructured. In a case that IPv4 is specified, it indicates that transmission and/or reception of data is performed using IPv4. In a case that IPv6 is specified, it indicates that transmission and/or reception of data is performed using IPv6. In a case that Ethernet is specified, it indicates that transmission and/or reception of an Ethernet frame is performed. Alternatively, Ethernet may indicate that communication using the IP is not performed. In a case that Unstructured is specified, it indicates that data is transmitted and/or received to and/or from an application server in the DN or the like by using a Point-to-Point (P2P) tunneling technique. For the P2P tunneling technique, for example, a UDP/IP encapsulation technique may be used. Note that the PDU session type may include the IP, in addition to the above. The IP can be specified in a case that the UE can use both of IPv4 and IPv6.

Next, the Public land mobile network (PLMN) is a communication network that provides mobile radio communication services. The PLMN is a network managed by an operator who is a network operator, and the operator can be identified by a PLMN ID. A PLMN that matches a Mobile Network Code (MNC) and a Mobile Country Code (MCC) of an International Mobile Subscription Identity (IMSI) of the UE may be a Home PLMN (HPLMN). Furthermore, the UE may hold, in the USIM, an Equivalent PLMN list for identifying one or multiple Equivalent PLMNs (EPLMNs). A PLMN different from the HPLMN and/or the EPLMN may be a VPLMN (Visited PLMN). A PLMN with which the UE has successfully registered may be a Registered PLMN (RPLMN).

Next, the registered PLMN is a PLMN with which the UE is registered.

Next, an equivalent PLMN is a PLMN that is treated as the same PLMN as any PLMN in a network. For example, an equivalent PLMN may be one or more PLMNs that are treated the same as registered PLMN(s).

Next, PLMN selection may be a procedure for the UE to select a PLMN. Here, PLMN selection may be performed in a case that the UE connects to a PLMN. Here, PLMN selection may be referred to as a PLMN selection process, or may be referred to as a PLMN selection procedure.

Here, the UE not operating in an SNPN access mode or an SNPN access operation mode may perform PLMN selection. The UE operating in the SNPN access mode or the SNPN access operation mode need not perform PLMN selection. PLMN selection may be performed without registration. In other words, PLMN selection may be performed in a case that the UE has not completed registration with the network. PLMN selection may include an automatic PLMN selection mode and a manual PLMN selection mode. Note that PLMN selection may indicate the automatic PLMN selection mode, or may indicate the manual PLMN selection mode.

Next, a tracking area is a single or multiple ranges that can be expressed using location information of the UE_A 10 managed by the core network. Note that the tracking area may include multiple cells. Furthermore, the tracking area may be a range in which a control message such as paging is broadcast, or may be a range in which the UE_A 10 can move without performing a handover procedure. Furthermore, the tracking area may be a routing area, may be a location area, or may be any area similar to these. The tracking area may be hereinafter a TA. The tracking area may be identified by a Tracking Area Identity (TAI) including a Tracking area code (TAC) and a PLMN.

Next, the Registration area is a set of one or multiple TAs allocated to the UE by the AMF. Note that, while moving within one or multiple TAs included in a registration area, the UE_A 10 may be able to move without transmitting and/or receiving a signal for updating the tracking area. In other words, the registration area may be an information group indicating an area in which the UE_A 10 can move without performing a tracking area update procedure. The registration area may be identified by a TAI list configured by one or multiple TAIs.

Next, a UE ID is information for identifying the UE. For example, the UE ID may be a SUCI, a SUPI, an IMSI, a GUTI, a 5G-GUTI, an IMEI, an IMEISV, a TMSI, or a 5G-S-TMSI. Alternatively, the UE ID may be other information configured by an application or within the network. Moreover, the UE ID may be information for identifying the user.

Next, the Subscription Concealed Identifier (SUCI) may be a privacy preserving identifier including a concealed SUPI. The SUCI may include a SUPI Type, a Home Network Identifier, a Routing Indicator, a Protection Scheme Id, a Home Network Public Key Identifier, and a Scheme Output.

Next, the Subscription Permanent Identifier (SUPI) may be a globally unique identifier allocated to each subscriber in the 5G system. The SUPI may be defined as a SUPI type and an IMSI, an NSI, a Global Cable Identifier (GCI), or a Global Line Identifier (GLI). The SUPI type may indicate an IMSI, an NSI, a GCI, or a GLI. In other words, in a case that the SUPI type indicates an IMSI, the SUPI may include a SUPI type indicating the IMSI and the IMSI.

Similarly, in a case that the SUPI type indicates an NSI, the SUPI may include a SUPI type indicating the NSI and the NSI. In a case that the SUPI type indicates a GCI, the SUPI may include a SUPI type indicating the GCI and the GCI. In a case that the SUPI type indicates a GLI, the SUPI may include a SUPI type indicating the GLI and the GLI.

Next, the International Mobile Subscription Identity (IMSI) may include a Mobile Country Code (MCC), a Mobile Network Code (MNC), and a Mobile Subscriber Identification Number (MSIN).

Next, the 5G Globally Unique Temporary Identifier (5G-GUTI) may be information for providing an unambiguous identifier of the UE, which does not reveal the UE or the user's permanent identity. The 5G-GUTI may be information that also allows identification of the AMF and the network. The 5G-GUTI may be information used by the network and the UE to establish identity of the UE. The 5G-GUTI may include two elements for identifying the AMF to which the 5G-GUTI is allocated and for uniquely identifying the UE in the AMF to which the 5G-GUTI is allocated. The former may be a Globally Unique AMF Identifier (GUAMI), and the latter may be a 5G-Temporary Mobile Subscriber Identity (5G-TMSI). In other words, the 5G-GUTI may include the GUAMI and the 5G-TMSI.

Next, the International Mobile station Equipment Identity (IMEI) may include a Type Allocation Code (TAC), a Serial Number (SNR), and a Check Digit (CD)/Spare Digit (SD).

Next, the International Mobile station Equipment Identity and Software Version number (IMEISV) may include a Type Allocation Code (TAC), a Serial Number (SNR), and a Software Version Number (SVN).

Next, the 5G S-Temporary Mobile Subscription Identifier (5G-S-TMSI) may be an abbreviation of the 5G-GUTI. The 5G-S-TMSI may enable a more efficient radio signaling procedure (for example, paging (also referred to as a paging procedure) and a service request (also referred to as a service request procedure)). For paging, the UE may be paged using the 5G-S-TMSI. The 5G-S-TMSI may include an AMF Set ID, an AMF Pointer, and a 5G-TMSI.

Next, the Media Access Control address (MAC address) may be a hardware address of a device connected to shared media. The MAC address may be a unique identification number given to the UE or the network apparatus.

Next, an IEEE Extended Unique Identifier (EUI-64) may be a 64-bit long identifier standardized by the IEEE. The EUI-64 may be used in a case of automatically generating an IPv6 address.

Next, a Permanent Equipment Identifier (PEI) may be information for identifying the UE. The PEI may be defined as a PEI type, an IMEI, an IMEISV, a MAC address, or an EUI-64.

Here, the PEI type may indicate the IMEI, the IMEISV, the MAC address, or the EUI-64. In other words, in a case that the PEI type indicates an IMEI, the PEI may include a PEI type indicating the IMEI and the IMEI. Similarly, in a case that the PEI type indicates an IMEISV, the PEI may include a PEI type indicating the IMEISV and the IMEISV. In a case that the PEI type indicates a MAC address, the PEI may include a PEI type indicating the MAC address and the MAC address. In a case that the PEI type indicates an EUI-64, the PEI may include a PEI type indicating the EUI-64 and the EUI-64.

Next, a 5GS mobile identity may be an IE for providing a SUCI, a 5G-GUTI, an IMEI, an IMEISV, a 5G-S-TMSI, a MAC address, and an EUI-64. The 5GS mobile identity may be referred to as a 5GS mobile identity information element (IE).

Next, the Non-Public Network (NPN) is a private network used by specific users for specific purposes. As NPNs, two types of NPNs, namely a Stand-alone Non-Public Network (SNPN) and a Public Network Integrated NPN (PNI-NPN), are present. Note that the NPN may indicate an SNPN, may indicate a PNI-NPN, or may indicate both.

Next, the SNPN is a network that is operated by an NPN operator and not affected by function units provided by a PLMN. In other words, the SNPN is an NPN-only network independent of publicly available PLMNs. The SNPN may be a network identified by an SNPN identity (SNPN ID). Note that the SNPN ID may be information that is a combination of a PLMN ID and a Network identifier (NID). Note that the PLMN ID used for the SNPN ID may be information reserved for a private network. For example, the MCC included in the PLMN ID may be 999. Furthermore, in a case that the UE is registered with the SNPN, the registered SNPN may be referred to as a registered SNPN or an RSNPN (registered SNPN).

Next, the NID is information for identifying a network. An SNPN may be identified by a combination of a PLMN ID and an NID. The NID may be unique information in the SNPN, or may be globally unique information.

Next, the PNI-NPN is a network implemented using function units of the PLMN. In other words, the PNI-NPN is an NPN virtually implemented in the PLMN. Furthermore, the PNI-NPN is an NPN that can be created via the PLMN. Note that the PNI-NPN may be implemented using a function of a network slice. Specifically, the PNI-NPN may be a network that can be implemented by using a network slice allocated for the NPN. In this case, the PNI-NPN may be identified by S-NSSAI, or may be identified by a combination of S-NSSAI and a CAG ID. Furthermore, the PNI-NPN may be implemented using the DN. Specifically, the PNI-NPN may be a network that can be implemented by using the DN for the NPN. In this case, the PNI-NPN may be identified by a DNN, or may be identified by a combination of a DNN and a CAG ID.

Next, the Closed Access Groups (CAG) are groups used in a case of implementing a PNI-NPN. The CAG may be a group identified by the CAG ID. The CAG may be used to prevent UEs not allowed by an NPN from attempting to access a network slice allocated for the NPN.

Next, the CAG ID is information for identifying the CAG in the PLMN. Furthermore, the CAG ID is a unique identifier in the PLMN.

Next, a CAG cell is a cell in which only members of the CAG can obtain normal services.

Next, an SNPN enable UE may be the UE that can use the SNPN. The SNPN enable UE may store at least one piece of information regarding the SNPN. In other words, configuration information of the SNPN enable UE may include information indicating that the SNPN is available. Furthermore, the SNPN enable UE may support an SNPN access mode or an SNPN access operation mode. In other words, the SNPN enable UE may operate in the SNPN access mode or the SNPN access operation mode.

Next, the SNPN access mode may be a mode for the UE to select the SNPN. The SNPN access mode may be a mode in which the UE has registered with the SNPN. Furthermore, the SNPN access mode may also be a mode in which the UE has been connected to the SNPN. In other words, the UE operating in the SNPN access mode may select only the SNPN in a case of network selection. More specifically, the UE operating in the SNPN access mode may select only the SNPN via a Uu interface in a case of network selection. In other words, the UE operating in the SNPN access mode may select the SNPN without selecting the PLMN in a case of network selection. Here, the UE operating in the SNPN access mode may be referred to as the UE in the SNPN access mode. Furthermore, the UE in the SNPN access mode may be the SNPN enable UE.

Next, the SNPN access operation mode is the SNPN access mode or a mode of connecting to an SNPN via non-3GPP access. Here, “non-3GPP access” in the SNPN may refer to a case that the UE is connected to the SNPN via the PLMN. The UE may also operate in the SNPN access operation mode in a case that the UE operates in the SNPN access mode. The UE may also not operate in the SNPN access operation mode in a case that the UE does not operate in the SNPN access mode. A UE in the SNPN access mode may also be a UE in the SNPN access operation mode. Note that the SNPN access operation mode may be interpreted as the SNPN access mode.

Next, SNPN selection may be a procedure for the UE to select the SNPN. SNPN selection may be a procedure performed in a case that the UE connects to the SNPN. SNPN selection may be referred to as an SNPN selection process, or may be referred to as an SNPN selection procedure. SNPN selection may be a process for the UE to select the SNPN. SNPN selection may be a process performed in a case that the UE connects to the SNPN.

The UE operating in the SNPN access mode or the SNPN access operation mode may perform SNPN selection. The UE not operating in the SNPN access mode or the SNPN access operation mode need not perform SNPN selection. SNPN selection may include an automatic SNPN selection mode and a manual SNPN selection mode. SNPN selection may be performed without registration. In other words, SNPN selection may be performed in a case that the UE has not completed registration with the network. Note that SNPN selection may indicate the automatic SNPN selection mode, or may indicate the manual SNPN selection mode.

Next, an equivalent SNPN may be an SNPN that is treated the same as any SNPN. For example, an equivalent SNPN may be one or more SNPNs that are treated the same as registered SNPN(s). Furthermore, an equivalent SNPN may be an SNPN that is treated the same as any SNPN. For example, an equivalent SNPN may be one or more SNPNs that are treated the same as registered SNPN(s).

Furthermore, the equivalent SNPN may be one or multiple SNPNs identified by the same SNPN ID as any SNPN. Note that the equivalent SNPN may be referred to as equivalent SNPN(s).

The equivalent SNPN may be managed in a list. An equivalent SNPN list may indicate one list including equivalent SNPN(s). The equivalent SNPN list may be referred to as a list of equivalent SNPNs.

Note that an equivalent SNPN provided from a network may be an equivalent SNPN for the network. An equivalent SNPN provided from an onboarding network may be an equivalent SNPN for the onboarding network.

Next, a “temporarily forbidden SNPNs” list may be independently managed for each access type. In other words, the “temporarily forbidden SNPNs” list may be managed for each access (3GPP access and non-3GPP access). The “temporarily forbidden SNPNs” list may be a list of SNPNs to which the UE cannot temporarily access. In a case that the UE supports onboarding services in the SNPN, an additional “temporarily forbidden SNPNs” list for onboarding services may be managed.

Next, a “permanently forbidden SNPNs” list may be independently managed for each access type. In other words, the “permanently forbidden SNPNs” list may be managed for each access (3GPP access and non-3GPP access). The “permanently forbidden SNPNs” list may be a list of SNPNs to which the UE cannot permanently access. In a case that the UE supports onboarding services in the SNPN, an additional “permanently forbidden SNPNs” list for onboarding services may be managed.

The UE may not be able to initiate the registration procedure for the SNPNs in the “temporarily forbidden SNPNs” list or the “permanently forbidden SNPNs” list.

Next, the home network may be a network that owns a subscription or credentials of the UE being currently used. The home network may be the PLMN, or may be the NPN. Here, the NPN may be the SNPN or the PNI-NPN.

Next, a CAG information list may be a list including one or more CAG IDs. The CAG information list may be an Extended CAG information list.

The CAG information list may include zero or more entries. Each entry may include one PLMN ID. Each entry may include an Allowed CAG list. The Allowed CAG list may include zero or more CAG-IDs. Optionally, each entry may include an indication that the UE is allowed to perform connection to only the 5GS via the CAG cell.

Next, the UE attaching via the E-UTRAN may perform location registration (LR) through the tracking area update procedure. The UE registered via the NG-RAN may perform location registration (LR) through the registration procedure.

Next, onboarding services in the SNPN may allow the UE to connect to the SNPN indicating that onboarding is allowed by using default UE credentials for primary authentication so that the UE includes one or more entries of a “list of subscriber data”. Note that the onboarding services in the SNPN may be referred to as onboarding services, or may be referred to as onboarding.

In a case that the UE is registered for onboarding services in the SNPN, services other than the onboarding services in the SNPN may be unavailable. In a case that the UE is not registered for onboarding services in the SNPN, the onboarding services in the SNPN may be unavailable.

Here, the UE performing registration for onboarding services in the SNPN may mean the UE indicating SNPN onboarding registration in a 5GS registration type information element.

Note that the registration procedure for onboarding services may be referred to as an onboarding procedure.

Next, an Onboarding Network (ON) may be a network for which onboarding is allowed. The onboarding network may be a network that provides initial registration and/or access to the UE for onboarding. Note that the onboarding network may be referred to as an ONN.

Here, the onboarding network may be a PLMN, and may be referred to as an ON-PLMN. Furthermore, the onboarding network may be an SNPN, and may be referred to as an ON-SNPN.

The onboarding network may be a PLMN or an onboarding SNPN that enables a registered UE to perform Remote Provisioning.

Next, a Provisioning Server is an entity that provides credentials to the UE to enable SNPN connection.

Here, the provisioning server may be present in the onboarding network. Furthermore, the provisioning server may be present in an external DN different from the onboarding network.

Next, a Subscription Owner SNPN (SO-SNPN) may be an SNPN having a subscription of the UE. The SO-SNPN may be an SNPN that provides subscription data to the UE via the provisioning server during the onboarding procedure. Note that the ON-SNPN and the SO-SNPN may be the same SNPN.

Next, a first SNPN may be an SNPN indicating that onboarding services are allowed. The first SNPN may be an SNPN that matches onboarding service information. In a case that the onboarding service information is configured in advance, the first SNPN may be an SNPN that matches the onboarding service information. In other words, the first SNPN may be an SNPN that indicates that onboarding services are allowed and matches the onboarding service information.

Next, a second SNPN may be an SNPN not indicating that onboarding services are allowed. The second SNPN may be an SNPN that does not match the onboarding service information. In a case that the onboarding service information is configured in advance, the second SNPN may be an SNPN that does not match the onboarding service information. In other words, the second SNPN may be an SNPN that does not indicate that onboarding services are allowed and does not match the onboarding service information. In yet other words, in a case that the second SNPN does not indicate that onboarding services are allowed and the onboarding service information is configured in advance, the second SNPN may be an SNPN that does not match the onboarding service information.

### 2.7. Description of Identification Information According to Present Embodiment

Next, the identification information transmitted and/or received, and/or stored, and/or managed by each apparatus in the present embodiment will be described.

First, first identification information is a 5GS registration type information element (5GS registration type IE). The first identification information may be an information element for indicating a type of requested registration. The first identification information may indicate information indicating initial registration, mobility registration updating, periodic registration updating, emergency registration, SNPN onboarding registration, disaster roaming mobility registration updating, or disaster roaming initial registration.

Next, second identification information may be UE capability information. The second identification information may be information indicating that the function using the equivalent SNPN, the equivalent SNPN list, or the equivalent SNPN is supported. The second identification information may be information indicating that the function using the equivalent SNPN, the equivalent SNPN list, or the equivalent SNPN is not supported. The second identification information may be information indicating whether or not the function using the equivalent SNPN, the equivalent SNPN list, or the equivalent SNPN is supported.

The second identification information may be an Equivalent SNPN indicator (ESI). Here, the ESI may be set with information indicating whether or not the function using the equivalent SNPN, the equivalent SNPN list, or the equivalent SNPN is supported. The ESI may be set with information indicating that the function using the equivalent SNPN, the equivalent SNPN list, or the equivalent SNPN is supported. The ESI may be set with information indicating that the function using the equivalent SNPN, the equivalent SNPN list, or the equivalent SNPN is not supported.

The second identification information may be information in a 5GMM capability Information Element (IE). Here, the 5GMM capability IE may be a 5GMM capability.

Next, 10th identification information may be an equivalent SNPN. The 10th identification information may be a list of equivalent SNPNs. The 10th identification information may be one list including one or more equivalent SNPNs. Here, entries in the list may include SNPN IDs.

The 10th identification information may be a list not including equivalent SNPNs. In other words, the 10th identification information may be an empty list.

Next, 11th identification information may be a cause value indicating a reason why a request of the UE is rejected. The 11th identification information may be a 5GMM cause. The 11th identification information may be a 5GMM cause value.

Note that the 11th identification information may be a cause value indicating #3 (Illegal UE), #6 (Illegal ME), #7 (5GS services not allowed), #13 (Roaming not allowed in this tracking area), #22 (Congestion), #62 (No network slices available), #74 (Temporarily not authorized for this SNPN), or #75 (Permanently not authorized for this SNPN).

Here, #3 (Illegal UE) and #6 (Illegal ME) may be cause values indicating an illegal UE. #7 (5GS services not allowed) may be a cause value indicating that 5GS services are not allowed. #13 (Roaming not allowed in this tracking area) may be a cause value indicating that roaming in the tracking area is not allowed. #22 (Congestion) may be a cause value indicating congestion. #62 (No network slices available) may be a cause value indicating that network slices are unavailable. #74 (Temporarily not authorized for this SNPN) may be a cause value indicating that the SNPN is temporarily not authorized. #75 (Permanently not authorized for this SNPN) may be a cause value indicating that the SNPN is permanently not authorized.

The 11th identification information may be a cause value other than the above. For example, the 11th identification information may be a cause value indicating #9 (UE identity cannot be derived by the network), #10 (implicitly de-registered), #11 (PLMN not allowed), #12 (Tracking area not allowed), #15 (No suitable cells in tracking area), #27 (N1 mode not allowed), #31 (Redirection to EPC required), #72 (Non-3GPP access to 5GCN not allowed), #73 (Serving network not authorized), #76 (Not authorized for this CAG or authorized for CAG cells only), #77 (Wireline access area not allowed), #78 (PLMN not allowed to operate at the present UE location), #79 (UAS services not allowed), or #80 (Disaster roaming for the determined PLMN with disaster condition not allowed).

Next, 12th identification information may be a cause value indicating a reason why a request of the UE is rejected. The 12th identification information may be a 5GMM cause value indicating that the equivalent SNPN is not allowed. The 12th identification information may be a 5GMM cause.

### 3. Description of Procedures Used in Each Embodiment

Next, procedures used in each embodiment will be described.

Note that, in each embodiment, a case that each of the HSS and the UDM, the PCF and the PCRF, the SMF and the PGW-C, and the UPF and the PGW-U is configured as a single apparatus (that is, the same physical hardware, or the same logical hardware, or the same software) as illustrated in FIG. 2 will be described as an example. However, the details described in the present embodiment can also be applied to a case that each of the combinations is configured as different apparatuses (that is, different pieces of physical hardware, or different pieces of logical hardware, or different pieces of software). For example, between the apparatuses/functions, data may be directly transmitted and/or received, data may be transmitted and/or received via an N26 interface between the AMF and the MME, or data may be transmitted and/or received via the UE.

### 3.1. Acquisition of System Information

First, processing related to acquisition of system information will be described.

Acquisition of the system information may be the UE acquiring and storing information broadcast by the NG-RAN node that provides access to one or multiple SNPNs.

Here, the information broadcast by the NG-RAN may include one or multiple PLMN IDs, and/or a list of one or multiple NIDs for each PLMN ID for identifying the NPN to which the NG-RAN provides access. Furthermore, presence of the NID list for the PLMN ID may indicate that the associated PLMN ID and NID identify the SNPN. In other words, the UE may be able to identify the SNPN, based on the NID list for each PLMN ID broadcast by the NG-RAN node. Thus, the NG-RAN node may broadcast information for identifying the SNPN, and the UE may receive and store the information for identifying the SNPN.

The information broadcast by the NG-RAN node may further include human-readable network names (human-readable names) for each SNPN, information for hindering the UE not supporting the SNPN from accessing a cell, an indication for each SNPN as to whether or not access of the UE using credentials from a Credentials Holder (CH) is supported, a list of Group IDs (GINs) for network selection supported for each SNPN, and/or an indication for each SNPN as to whether registration attempts from the UE not explicitly configured to select the SNPN are allowed, which is used only for manual SNPN selection.

Furthermore, in a case that the SNPN supports onboarding of the UE to the SNPN, in addition to the above, the NG-RAN node may include an indication (onboarding enabled indication) indicating whether or not onboarding is currently enabled in the SNPN and broadcast the indication to each cell. In other words, for example, the NG-RAN node may broadcast information for identifying the ON-SNPN in a cell in which the SNPN can be used as the ON-SNPN.

Acquisition of the system information by the UE may be based on a System Information acquisition procedure. The UE that acquires the system information may operate in the SNPN access mode, or may not operate in the SNPN access mode.

Note that the UE may perform SNPN selection or SNPN selection for onboarding services in network selection described below by using or considering information of the SNPN included in the received system information.

### 3.2. Network Selection

Next, processing related to network selection will be described. Network selection is processing for the UE in the deregistered state to select a PLMN, an NPN, or an SNPN to be registered with before performing the registration procedure. For example, the UE may perform network selection to select a different network at a power input time, in a case that a SIM is removed or inserted, or in a case of failing in the registration procedure.

PLMN selection and SNPN selection will be described below.

### 3.2.1. PLMN Selection

First, PLMN selection will be described.

PLMN selection may be a procedure for the UE to select a PLMN. Here, PLMN selection may be performed in a case that the UE connects to a PLMN. Here, PLMN selection may be referred to as a PLMN selection process, or may be referred to as a PLMN selection procedure.

Here, the UE not operating in the SNPN access mode or the SNPN access operation mode may perform PLMN selection. The UE operating in the SNPN access mode or the SNPN access operation mode need not perform PLMN selection. PLMN selection may be performed without registration. In other words, PLMN selection may be performed in a case that the UE has not completed registration with the network. PLMN selection may include an automatic PLMN selection mode and a manual PLMN selection mode. Note that PLMN selection may indicate the automatic PLMN selection mode, or may indicate the manual PLMN selection mode.

PLMN selection may include two modes, namely an automatic PLMN selection mode and a manual PLMN selection mode.

PLMN selection may be GAG selection. In a case that the UE supports the CAG, PLMN selection may be CAG selection.

Steps of PLMN selection will be described below.

The UE may select other PLMNs, in a case of being available and allowable for (i), (ii), (iii), (iv), and (v), and may attempt registration in the following order.
(i) The UE may select an HPLMN, or an available EHPLMN having a high priority.
(ii) The UE may select each PLMN in a “User Controlled PLMN Selector with Access Technology” data file in a SIM.
(iii) The UE may select each PLMN in an “Operator Controlled PLMN Selector with Access Technology” data file in the SIM, or each PLMN stored in the UE.
(iv) The UE may select other PLMNs having received high-quality signals in random order.
(v) The UE may select other PLMNs in decreasing order of signal quality.
(vi) The UE may select PLMNs for forbidden PLMNs that broadcast the PLMN ID of a UE-determined PLMN in the disaster state or broadcast a disaster-related indication and that meet the following conditions.
(vi-a) (vi-a) may be the behavior in a case that an indication of applicability of the list of PLMNs to be used in the disaster state provided by the VPLMN is configured to be true. The UE may select, if any, each list in the list of PLMNs to be used in the disaster state being stored in the UE and associated with the PLMN ID of the UE-determined PLMN in the disaster state in order based on the list. Otherwise, in a case that the UE does not have a stored list of PLMNs to be used in the disaster state being associated with the PLMN ID of the UE-determined PLMN in the disaster state, the UE may select, if any, each PLMN in the list of PLMNs to be used in the disaster state stored in the UE and associated with the PLMN ID of the HPLMN in order based on the list.
(vi-b) In a case that an indication of applicability of the list of PLMNs to be used in the disaster state provided by the VPLMN is configured to be false, the UE may select, if any, each PLMN in the list of PLMNs to be used in the disaster state being stored in the UE and associated with the HPLMN in order based on the list.
(vii) The UE may select PLMNs for other forbidden PLMNs that broadcast the PLMN ID of the UE-determined PLMN in the disaster state or broadcast a disaster-related indication in random order.

In a case of performing the above procedure, the following requirements may be applied.
(a) The behavior in a case that the UE supports the CAG in (i) to (vii) will be described below.
(a-1) In a case that the UE is provided with a non-empty CAG information list, the UE may consider the PLMN indicated by an NG-RAN cell in only one of the following cases.
(a-1-A) In a case that the cell is a CAG cell, the cell broadcasts a CAG-ID for a PLMN in which entries having the PLMN ID of the PLMN are present in the CAG information list, and the CAG ID is included in the Allowed CAG list.
(a-1-B) Alternatively, in a case that the cell is not a CAG cell, and entries having the PLMN ID of the PLMN are not present in the CAG information list. Alternatively, in a case that the cell is not a CAG cell, and an indication that entries having the PLMN ID of the PLMN in the CAG information list are present but the UE is allowed to access only the 5GS via the CAG cell is not included in the entries.
(a-2) In a case that the UE is provided with an empty CAG information list or the UE is not provided with the CAG information list, the UE may consider the PLMN indicated by an NG-RAN cell only in a case that the cell is not a CAG cell.

In a case that one or more available and allowable PLMNs are present but registration with the PLMNs fails due to a failure in location registration or entries in the CAG information list block registration attempts, the UE selects such PLMN(s) again and transitions to a limited service state.

The UE that has completed the processing of PLMN selection described above may perform the registration procedure with the selected network.

Furthermore, in a case that the UE performs initial registration with the PLMN, the UE may indicate that the PLMN selected in PLMN selection has the PLMN ID selected by the NG-RAN node. Furthermore, the NG-RAN may notify the AMF of the PLMN ID for identifying the selected PLMN indicated by the UE.

### 3.2.2. SNPN Selection

Next, SNPN selection will be described.

SNPN selection may be a procedure for the UE to select the SNPN. SNPN selection may be a procedure performed in a case that the UE connects to the SNPN. SNPN selection may be referred to as an SNPN selection process, or may be referred to as an SNPN selection procedure. The SNPN selection procedure may be an automatic SNPN selection procedure, or may be a manual SNPN selection procedure. SNPN selection may be a process for the UE to select the SNPN. SNPN selection may be a process performed in a case that the UE connects to the SNPN.

The UE operating in the SNPN access mode or the SNPN access operation mode may perform SNPN selection. The UE not operating in the SNPN access mode or the SNPN access operation mode need not perform SNPN selection. SNPN selection may include an automatic SNPN selection mode and a manual SNPN selection mode. SNPN selection may be performed without registration. In other words, SNPN selection may be performed in a case that the UE has not completed registration with the network. Note that SNPN selection may indicate the automatic SNPN selection mode, or may indicate the manual SNPN selection mode.

SNPN selection may be referred to as an SNPN selection mode procedure. The SNPN selection mode procedure may be an automatic SNPN selection mode procedure, or may be a manual SNPN selection mode procedure.

The SNPN selection mode procedure may be a procedure performed in the automatic SNPN selection mode, or may be a procedure performed in the manual SNPN selection mode. In other words, the automatic SNPN selection mode procedure may be a procedure performed in the automatic SNPN selection mode, and the manual SNPN selection procedure may be a procedure performed in the manual SNPN selection mode.

SNPN selection may include two modes, namely an automatic SNPN selection mode and a manual SNPN selection mode.

SNPN selection may be SNPN selection for onboarding services in the SNPN.

ON-SNPN selection may be SNPN selection for onboarding services, and may be performed in a case that the UE performs UE onboarding. Note that ON-SNPN selection may be a form of SNPN selection.

The UE that performs SNPN selection or ON-SNPN selection may operate in the SNPN access mode.

SNPN selection or ON-SNPN selection may have an Automatic SNPN selection mode and a Manual SNPN selection mode. Note that automatic SNPN selection may be a form of automatic network selection, and manual SNPN selection may be a form of manual network selection.

Here, in the automatic SNPN selection mode, the UE may select the SNPN, based on the last registered NSPN, a subscribed SNPN, the “list of preferred SNPNs” being a list of SNPNs managed by the UE or the CH, or the like.

Here, in the manual SNPN selection mode, the UE may provide a user with a list of SNPNs and associated human-readable network names for available SNPNs.

In acquisition of the system information described above, the UE may perform SNPN selection by using or considering the information received from the NG-RAN node and/or the information for identifying the SNPN stored by the UE. Here, the UE that supports UE onboarding may be configured with ON-SNPN selection information in advance. Furthermore, the UE that performs ON-SNPN selection may compare the ON-SNPN selection information configured in advance and the system information acquired from the NG-RAN node described above with each other. More specifically, in ON-SNPN selection, the UE may compare, for example, the information (SNPN network identifier) and/or the GIN for identifying the SNPN included in the ON-SNPN selection information configured in advance and the onboarding enabled indication included in the acquired system information described above with each other.

Steps of SNPN selection will be described below.

In a case that at least one entry is present in the list of subscriber data, the UE may select, if any, one entry in the list of subscriber data to be used for automatic SNPN selection. In a case that at least one entry is present in the list of subscriber data, the UE may select, if any, PLMN subscription to be used for automatic SNPN selection.

In a case that zero or more entries are present in the list of subscriber data, the UE has a USIM having PLMN subscription, and the UE is provided with an SNPN selection parameter related to the PLMN subscription, the UE may select, if any, one entry in the list of subscriber data to be used for automatic SNPN selection. In a case that zero or more entries are present in the list of subscriber data, the UE has a USIM having PLMN subscription, and the UE is provided with an SNPN selection parameter related to the PLMN subscription, the UE may select, if any, PLMN subscription to be used for automatic SNPN selection.

The UE may select one SNPN, in a case of being available and allowed, in the following order of (a) to (c).
(a) The UE may select an SNPN with which the UE is last registered or an equivalent SNPN. Note that, in a case of SNPN selection after completion of the registration procedure for onboarding services, the UE need not select the equivalent SNPN.
(b) The UE may select, if any, an SNPN identified by an SNPN identifier of a subscribed SNPN in the selected entry of the list of subscriber data in the UE.
(c) In a case that the UE supports connection to an SNPN using credentials from a credentials holder, an SNPN using an SNPN selection parameter of the selected entry of the list of subscriber data, or an SNPN related to the selected PLMN, the UE may select the following SNPN.
(c-1) The UE may select an SNPN that broadcasts an indication of support of connection using credentials from a credentials holder and is identified by the SNPN identifier included in a user-controlled priority list of priority SNPNs.
(c-2) The UE may select an SNPN that broadcasts an indication of support of connection using credentials from a credentials holder and is identified by the SNPN identifier included in a credentials holder-controlled priority list of priority SNPNs.
(c-3) The UE may select an SNPN that broadcasts an indication of support of connection using credentials from a credentials holder and broadcasts the GIN included in a credentials holder-controlled priority list of GINs.
(c-4) The UE may select an SNPN that is not included in either the SNPN selection parameter of entries of the list of subscriber data or the SNPN selection parameter related to PLMN subscription, does not broadcast the GIN included in the credentials holder-controlled priority list of GINs, and is identified by the SNPN identifier broadcasting an indication that the SNPN allows registration attempts from the UE not explicitly configured to select the SNPN.

The UE may limit search of the UE for NG-RAN access technology to the SNPN.

Once the UE has selected an SNPN and in a case that PLMN subscription is selected, the UE may attempt registration with the selected SNPN using the NG-RAN access technology, the subscriber identifier, and the credentials from the selected entry of the list of subscriber data or from the USIM.

In a case that the registration matches, the UE may indicate the selected SNPN.

In a case that SNPNs that are available, are allowed, and are identified by the SNPN identifiers in the entries of the list of subscriber data of the UE are not present and thus registration fails, the UE may indicate “no service” to the user, wait until a new SNPN becomes available, allowed, and identified by the SNPN identifier in the entries of the list of subscriber data of the UE, and repeat the SNPN selection mode procedure and/or the registration procedure.

In a case that SNPNs that are available, are allowed, and are identified by the SNPN identifiers in the entries of the list of subscriber data of the UE are present but registration with the SNPNs fails due to a failure in location registration, the UE may select one of the SNPNs again and transition to the limited service state.

Next, SNPN selection in onboarding services will be described.

In a case that the UE needs to connect to one SNPN for onboarding services in the SNPN, the UE may select one first SNPN.

In a case that one or more first SNPNs are available, the UE selects one of the first SNPNs, based on the SNPN priority list for onboarding services. In other words, in a case that one or more available first SNPNs are present, the UE selects one of the first SNPNs, based on the SNPN priority list for onboarding services.

For onboarding services in the SNPN, the UE need not select the second SNPN.

Once the UE has selected an SNPN for onboarding services, the UE may attempt initial registration for the onboarding services in the selected SNPN. Once the UE has selected an SNPN for onboarding services, the UE may attempt initial registration for the onboarding services in the SNPN on the selected SNPN by using the NG-RAN access technology and the default UE credentials for primary authentication.

In a case that registration fails and one or more other first SNPNs are available, the UE may select such other SNPN(s) based on the SNPN priority list for onboarding services, and may attempt initial registration for the onboarding services in the selected SNPN(s). In a case that registration fails and one or more other first SNPNs are available, the UE may select such other SNPN(s) based on the SNPN priority list for onboarding services, and may attempt initial registration for the onboarding services in the SNPN on the selected SNPN(s) by using the NG-RAN access technology and the default UE credentials for primary authentication.

In other words, in a case that registration fails and one or more other available first SNPNs are present, the UE may select such other SNPN(s) based on the SNPN priority list for onboarding services, and may attempt initial registration for the onboarding services in the selected SNPN(s). In a case that registration fails and one or more other available first SNPNs are present, the UE may select such other SNPN(s) based on the SNPN priority list for onboarding services, and may attempt initial registration for the onboarding services in the selected SNPN(s) by using the NG-RAN access technology and the default UE credentials for primary authentication.

In a case that registration fails and one or more other first SNPNs are available, the UE may perform SNPN selection not for onboarding services in the SNPN in the SNPN selection mode of the UE.

In other words, in a case that registration fails and one or more other available first SNPNs are present, the UE may perform SNPN selection not for onboarding services in the SNPN in the SNPN selection mode of the UE.

In a case that registration fails and other first SNPNs are unavailable, the UE may perform SNPN selection not for onboarding services in the SNPN in the SNPN selection mode of the UE.

In other words, in a case that registration fails and other available first SNPNs are not present, the UE may perform SNPN selection not for onboarding services in the SNPN in the SNPN selection mode of the UE.

In a case that the first SNPNs are unavailable and thus registration fails, the UE may indicate that there are no onboarding services to a higher layer, transition to the limited service state, wait until one new first SNPN becomes available, and repeat the SNPN selection mode procedure and/or the registration procedure. In a case that the first SNPNs are unavailable and thus registration fails, the UE may perform SNPN selection not for onboarding services in the SNPN in the SNPN selection mode of the UE.

In other words, in a case that available first SNPNs are not present and thus registration fails, the UE may indicate that there are no onboarding services to a higher layer, transition to the limited service state, wait until one new first SNPN becomes available, and repeat the SNPN selection mode procedure and/or the registration procedure. In a case that available first SNPNs are not present and thus registration fails, the UE may perform SNPN selection not for onboarding services in the SNPN in the SNPN selection mode of the UE.

In a case that one or more first SNPNs are present but registration with all of the first SNPNs fails due to a failure in location registration, the UE may indicate that there are no onboarding services to a higher layer, transition to the limited service state, wait until one new first SNPN becomes available, and repeat the SNPN selection mode procedure and/or the registration procedure. In a case that one or more first SNPNs are present but registration with all of the first SNPNs fails due to a failure in location registration, the UE may perform SNPN selection not for onboarding services in the SNPN in the SNPN selection mode of the UE.

The UE that has completed the processing of SNPN selection described above may perform the registration procedure with the selected network.

Furthermore, in a case that the UE performs initial registration with the SNPN or the ON-SNPN, the UE may indicate that the SNPN or the ON-SNPN selected in SNPN selection have the PLMN ID and the NID selected by the NG-RAN node. Furthermore, the NG-RAN may notify the AMF of the PLMN ID and the NID for identifying the selected SNPN indicated by the UE.

### 3.3. Registration Procedure

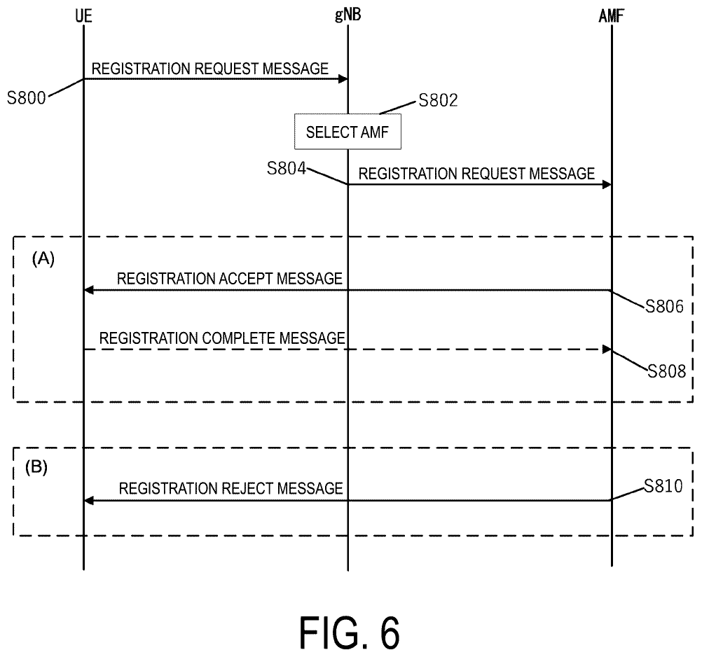

First, the Registration procedure will be described with reference to FIG. 6. The registration procedure is a procedure in the 5GS. In the present section, the present procedure refers to the registration procedure. The registration procedure is a procedure for registration with the access network_B, and/or the core network_B, and/or the DN initiated by the UE. In a case that the UE is in a state of not being registered with the network, for example, the UE can perform the present procedure at any timing, for example, a power input time. In other words, the UE can initiate the present procedure at any time as long as the UE is in a deregistered state (an RM-DEREGISTERED state). Each of the apparatuses (especially, the UE and the AMF) can transition to a registered state (an RM-REGISTERED state) based on completion of the Registration procedure. Note that the registered state may be managed by each apparatus for each access. Specifically, each apparatus may independently manage the registration state (registered state or deregistered state) for 3GPP access and the registration state for non-3GPP access.

Note that the registration procedure may be a Registration procedure for initial registration. The registration procedure may be a Registration procedure for mobility and periodic registration update. The registration procedure may be a Registration procedure for onboarding services. The registration procedure may be a Registration procedure for emergency services. The registration procedure may be referred to as registration.

In addition, the registration procedure may be a procedure for updating location registration information of the UE on the network, and/or periodically providing notification of a UE state from the UE to the network, and/or updating a specific parameter related to the UE on the network.

The network in the present procedure may be an SNPN, or may be a PLMN. The network in the present procedure may be an onboarding network.

The UE may perform the registration procedure after performing SNPN selection or PLMN selection.

The UE may also initiate a registration procedure in a case that the UE has performed mobility across a TA. In other words, the UE may initiate a registration procedure in a case that the UE has moved to a TA different from TAs indicated in a stored TA list. In addition, the UE may initiate the registration procedure in a case that a context of each apparatus needs to be updated due to disconnection and/or invalidation of a PDU session. Furthermore, in a case that there has been a change in capability information and/or a preference, related to PDU session establishment of the UE, the UE may initiate the registration procedure. In addition, the UE may periodically initiate the registration procedure. Furthermore, the UE may also initiate a registration procedure based on completion of a UE configuration update procedure. Note that the UE is not limited to this configuration, and can perform the registration procedure at any timing.

Furthermore, the UE may also initiate a registration procedure periodically even in a registered state.

Note that the registration procedure performed based on the mobility of the UE and the registration procedure performed periodically may also be expressed as a registration procedure for mobility and registration update. In other words, the registration procedure for mobility and registration update may be a registration procedure performed based on the mobility of the UE or may be a registration procedure performed periodically. Furthermore, the registration procedure for mobility and registration update may also be a registration procedure performed based on configuration update of the UE. Furthermore, the registration procedure for mobility and registration update may also be a registration procedure performed to establish a communication path for transmitting and/or receiving user data. Furthermore, the registration procedure for mobility and registration update may also be a registration procedure performed based on a request from the network. Furthermore, in other words, the registration procedure for mobility and registration update may be a registration procedure other than a registration procedure for initial registration.

Next, each step of the registration procedure will be described. Note that the registration procedure described below may be a registration procedure for initial registration or a registration procedure for mobility and registration update. Note that the AMF may be an AMF of the SNPN in a case that the registration procedure is performed in the SNPN, or may be an AMF of the PLMN in a case that the registration procedure is performed in the PLMN.

First, the UE transmits a Registration request message to the AMF (S800) (S802) (S804) to initiate the registration procedure. Specifically, the UE transmits an RRC message including a registration request message to the 5G AN (or the gNB) (S800). Note that the registration request message is a NAS message. The RRC message may be a control message transmitted and/or received between the UE and the 5G AN (or the gNB). In addition, the NAS message is processed in the NAS layer, and the RRC message is processed in the RRC layer. Note that the NAS layer is a layer higher than the RRC layer.

Here, the UE may transmit a registration request message and/or an RRC message including one or more pieces of identification information out of the first identification information to the second identification information. More specifically, the UE can transmit a registration request message and/or an RRC message including one or more pieces of identification information out of the first identification information to the second identification information and may also transmit a control message different from such messages, for example, a control message of a layer below the RRC layer (e.g., the MAC layer, the RLC layer, or the PDCP layer), including the one or more pieces of identification information.

Specifically, the UE may transmit the first identification information, and thereby indicate the 5GS registration type information element to the AMF. Here, the UE may indicate SNPN onboarding registration in the first identification information. In other words, the UE may indicate SNPN onboarding registration in the 5GS registration type information element to the AMF. In a case of indicating registration for onboarding services in the SNPN, the UE may transmit the first identification information.

The UE may transmit the second identification information, and thereby indicate that the UE supports the function using the equivalent SNPN, the equivalent SNPN list, or the equivalent SNPN to the AMF. The UE may transmit the second identification information, and thereby indicate that the UE does not support the function using the equivalent SNPN, the equivalent SNPN list, or the equivalent SNPN to the AMF. The UE may transmit the second identification information, and thereby indicate whether or not the UE supports the function using the equivalent SNPN, the equivalent SNPN list, or the equivalent SNPN to the AMF.

Note that the UE may transmit these pieces of identification information, to thereby indicate that the UE supports each function or indicate the request of the UE to the network. In addition, in a case that multiple pieces of identification information are transmitted and/or received, two or more pieces of identification information of these pieces of identification information may be configured as one or more pieces of identification information. Note that information indicating support of each function and information indicating a request for use of each function may be transmitted and/or received as the same piece of identification information, or may be transmitted and/or received as different pieces of identification information.

Further, by transmitting the registration request message including one or more pieces of identification information out of the first identification information to the second identification information, the UE may indicate the content indicated by the identification information included in the registration request message to the network.

Note that the UE may select or determine whether to include, in the registration request message, one or more pieces of identification information out of the first identification information to the second identification information based on subscriber information, a network state, user registration information, a context held by the UE, and/or the like.

Note that the UE may transmit the registration request message including identification information other than the first identification information to the second identification information.

In a case of receiving the RRC message including the registration request message, the 5G AN (or the gNB) selects an AMF to which the registration request message is transferred (S802). Note that the 5G AN (or the gNB) can select an AMF based on information included in the registration request message and/or the RRC message. The 5G AN (or the gNB) extracts the registration request message from the received RRC message and transfers the registration request message to the selected AMF (S804).

The AMF may perform a first condition fulfillment determination in a case that the AMF has received a registration request message. The first condition fulfillment determination is used by the network (or AMF) to determine whether to accept the request of the UE. In a case that the first condition fulfillment determination is true, the AMF initiates the procedure of (A) of FIG. 6, whereas in a case that the first condition fulfillment determination is false, the AMF initiates the procedure of (B) of FIG. 6.

Note that the first condition fulfillment determination may be performed based on reception of the registration request message, and/or each piece of identification information included in the registration request message, and/or subscriber information, and/or capability information of the network, and/or the operator policy, and/or a network state, and/or registration information of the user, and/or a context stored in the AMF, and/or the like. For example, the first condition fulfillment determination may be true in a case that the network allows the request from the UE, and the first condition fulfillment determination may be false in a case that the network does not allow the request from the UE. In addition, in a case that a network with which the UE is to be registered and/or an apparatus in the network supports the function requested by the UE, the first condition fulfillment determination may be true, whereas in a case that the network and/or the apparatus does not support the function requested by the UE, the first condition fulfillment determination may be false. Furthermore, in a case that the transmitted and/or received identification information is allowed, the first condition fulfillment determination may be true, whereas in a case that the transmitted and/or received identification information is not allowed, the first condition fulfillment determination may be false. Note that the conditions for determining whether the first condition fulfillment determination is true or false may not be limited to the conditions described above.

First, the case that the first condition fulfillment determination is true will be described. In the procedure of (A) of FIG. 6, the AMF transmits a Registration accept message to the UE via the 5G AN (or the gNB) as a response message to the registration request message (S806). Note that the registration accept message is a NAS message transmitted and/or received over the N1 interface, but is incorporated into an RRC message and transmitted and/or received between the UE and the 5G AN (the gNB).

The AMF may transmit the registration accept message including one or more pieces of identification information out of the 10th identification information to the 12th identification information. Note that, by transmitting such identification information, the AMF may indicate that the network supports each function or may indicate that the request of the UE has been accepted. In addition, in a case that multiple pieces of identification information are transmitted and/or received, two or more pieces of identification information of these pieces of identification information may be configured as one or more pieces of identification information. Note that information indicating support of each function and information indicating a request for use of each function may be transmitted and/or received as the same piece of identification information, or may be transmitted and/or received as different pieces of identification information.

Specifically, in a case of receiving the first identification information, the AMF may recognize that the UE indicates registration for onboarding services in the SNPN.

In a case of receiving the second identification information, the AMF may include the 10th identification information in the second control message. In other words, in a case that the UE indicates that the UE supports the function using the equivalent SNPN, the equivalent SNPN list, or the equivalent SNPN in the second identification information, the AMF may include the 10th identification information in the second control message. In a case that the UE indicates that the UE does not support the function using the equivalent SNPN, the equivalent SNPN list, or the equivalent SNPN in the second identification information, the AMF need not include the 10th identification information in the second control message.

Furthermore, the AMF may transmit the registration accept message including one or more pieces of identification information out of the 10th identification information to the 12th identification information, and thereby indicate the content indicated by these pieces of identification information to the UE. The AMF may transmit the registration accept message, and thereby indicate the content of these pieces of identification information to the UE.

Note that the AMF may select or determine whether to include, in the registration accept message, one or more pieces of identification information out of the 10th identification information to the 12th identification information based on each piece of received identification information, subscriber information, network capability information, an operator policy, a network state, user registration information, a context held by the AMF, and/or the like.

The AMF may transmit the registration accept message including identification information other than the 10th identification information to 12th identification information.

The AMF may indicate that the request of the UE has been accepted by transmitting a registration accept message based on each piece of received identification information, subscriber information, network capability information, an operator policy, a network state, user registration information, a context held by the AMF, and/or the like.

Furthermore, the AMF may also transmit a registration accept message including information indicating that a part of the request of the UE has been rejected or may transmit information indicating that a part of the request of the UE has been rejected to indicate a reason why a part of the request of the UE has been rejected. Furthermore, the UE may also recognize a reason why a part of the request of the UE has been rejected by receiving information indicating that a part of the request of the UE has been rejected. Note that the reason for rejection may be information indicating that the content indicated by the identification information received by the AMF is not allowed.

Next, the UE receives the registration accept message from the AMF via the 5G AN (the gNB) (S806). The UE may receive, from the AMF, the registration accept message including one or more pieces of identification information out of the 10th identification information to the 12th identification information.

Here, by receiving the registration accept message, the UE can recognize that the request of the UE in the registration request message has been accepted and the content of various pieces of identification information included in the registration accept message.

Specifically, in a case of receiving the 10th identification information, the UE may store the 10th identification information.

In a case of receiving the 10th identification information, the UE may delete the SNPN IDs in the “temporarily forbidden SNPNs” list or the “permanently forbidden SNPNs” list from the received 10th identification information. In other words, in a case of receiving the 10th identification information, and the registration not being registration for emergency services or registration for onboarding services in the SNPN, the UE may delete the SNPN IDs in the “temporarily forbidden SNPNs” list or the “permanently forbidden SNPNs” list from the received 10th identification information.

In a case of receiving the 10th identification information, the UE may add the SNPN ID of the registered SNPN that has transmitted the 10th identification information to the equivalent SNPN list stored in the UE.

In a case of receiving the 10th identification information, the UE may update the equivalent SNPN list stored in the UE.

In a case of receiving the 10th identification information, and the 10th identification information not including the equivalent SNPN list, the UE may delete the equivalent SNPN list stored in the UE.

Next, the UE may or may not transmit a registration complete message to the AMF via the 5G AN (the gNB) as a response message to the registration accept message (S808). Here, although the registration complete message is a NAS message transmitted and/or received over the N1 interface, the registration complete message is transmitted and/or received between the UE and the 5G AN (gNB) by being included in an RRC message.

Next, the AMF may or may not receive the registration complete message via the 5G AN (the gNB) (S808).

Each apparatus completes the procedure of (A) of FIG. 6, based on transmission and/or reception of the registration accept message and/or the registration complete message.

The UE may perform SNPN selection or PLMN selection, based on reception of the registration accept message. In this case, the UE may perform SNPN selection or PLMN selection without deleting the equivalent SNPNs.

The UE may perform SNPN selection or PLMN selection, based on transmission of the registration complete message. In this case, the UE may perform SNPN selection or PLMN selection without deleting the equivalent SNPNs.

Next, the case that the first condition fulfillment determination is false will be described. In the procedure (B) of FIG. 6, the AMF transmits a Registration reject message to the UE via the 5G AN (the gNB) as a response message to the registration request message (S810). Here, the registration reject message is a NAS message transmitted and/or received over the N1 interface, but is incorporated into an RRC message and transmitted and/or received between the UE and the 5G AN (the gNB).

Here, the AMF may transmit the registration reject message including one or more pieces of identification information out of the 10th identification information to the 12th identification information. Furthermore, the AMF may transmit these pieces of identification information, and may thereby indicate that the request of the UE has been rejected or indicate a reason why the request of the UE has been rejected.

Specifically, the network may transmit the 11th identification information, and thereby indicate a reason why registration has been rejected to the UE. The network may transmit the 11th identification information, and thereby indicate a cause value indicating #3 (Illegal UE), #6 (Illegal ME), #7 (5GS services not allowed), #13 (Roaming not allowed in this tracking area), #22 (Congestion), #62 (No network slices available), #74 (Temporarily not authorized for this SNPN), or #75 (Permanently not authorized for this SNPN) to the UE.

In a case that the network rejects registration of the UE because the UE is an illegal UE, the network may transmit the 11th identification information indicating #3 (Illegal UE) or #6 (Illegal ME). In a case that the network rejects registration of the UE because 5GS services are not allowed, the network may transmit the 11th identification information indicating #7 (5GS services not allowed). In a case that the network rejects registration of the UE because roaming in the tracking area is not allowed, the network may transmit the 11th identification information indicating #13 (Roaming not allowed in this tracking area). In a case that the network rejects registration of the UE because of congestion, the network may transmit the 11th identification information indicating #22 (Congestion). In a case that the network rejects registration of the UE because network slices are unavailable, the network may transmit the 11th identification information indicating #62 (No network slices available). In a case that the network rejects registration of the UE because the SNPN is temporarily not authorized, the network may transmit the 11th identification information indicating #74 (Temporarily not authorized for this SNPN). In a case that the network rejects registration of the UE because the SNPN is permanently not authorized, the network may transmit the 11th identification information indicating #75 (Permanently not authorized for this SNPN).

The network may transmit the 12th identification information, and thereby indicate a cause value indicating that the equivalent SNPN is not allowed to the UE.

In a case that the network rejects registration of the UE because the equivalent SNPN is not allowed, the network may transmit the 12th identification information.

Furthermore, the AMF may transmit the registration reject message including one or more pieces of identification information out of the 10th identification information to the 12th identification information, and thereby indicate the content indicated by the identification information included in the registration reject message to the UE. The AMF may transmit the registration reject message, and thereby indicate the content of these pieces of identification information to the UE.

The AMF may select or determine whether to include, in the registration reject message, one or more pieces of identification information out of the 10th identification information to the 12th identification information, based on each piece of received identification information, subscriber information, network capability information, an operator policy, a network state, user registration information, a context held by the AMF, and/or the like.

Furthermore, the AMF may also transmit a registration reject message to indicate that the request of the UE in the registration request message has been rejected. Furthermore, the AMF may also transmit a registration reject message including information indicating a reason for rejection or may transmit a reason for rejection to indicate the reason for rejection. Furthermore, the UE may also recognize a reason why the request of the UE has been rejected by receiving information indicating the reason why the request of the UE has been rejected. Note that the reason for rejection may be information indicating that the content indicated by the identification information received by the AMF is not allowed.

Next, the UE receives the registration reject message from the AMF via the 5G AN (the gNB) (S810). The UE may receive, from the AMF, the registration reject message including one or more pieces of identification information out of the 10th identification information to the 12th identification information. By receiving the registration reject message, the UE can recognize that the request of the UE in the registration request message has been rejected and the content of various pieces of identification information included in the registration reject message.

In a case of receiving the registration reject message, the UE may perform SNPN selection or PLMN selection. In this case, the UE may perform SNPN selection or PLMN selection without deleting the equivalent SNPN list.

The UE may also recognize that the request of the UE has been rejected in a case that the UE does not receive a registration reject message even in a case that a prescribed period of time has elapsed after transmitting a registration request message.

Each apparatus completes the procedure (B) in the present procedure based on transmission and/or reception of the registration reject message.

Note that the procedure of (B) of FIG. 6 may be initiated in a case that the procedure of (A) of FIG. 6 is cancelled.

Each apparatus completes the registration procedure, based on completion of the procedure of (A) or (B) of FIG. 6. Note that, based on completion of the procedure of (A) of FIG. 6, each apparatus may transition to a state (RM_REGISTERED state) in which the UE is registered with the network. Based on completion of the procedure of (B) of FIG. 6, each apparatus may maintain a state (RM_DEREGISTERED state) in which the UE is not registered with the network, or may transition to a state in which the UE is not registered with the network.

Furthermore, each apparatus may perform processing based on information transmitted and/or received in the registration procedure, based on completion of the registration procedure. For example, in a case that information indicating that a part of the request from the UE has been rejected is transmitted and/or received, the cause for rejection of the request from the UE may be recognized. Furthermore, each apparatus may also perform the present procedure again or may perform a registration procedure with the core network_B or another cell based on the reason why the request of the UE has been rejected.

Moreover, the UE may store the identification information received along with the registration accept message or the registration reject message or may recognize determination of the network based on the completion of the registration procedure.

Furthermore, the UE may perform SNPN selection or PLMN selection, based on completion of the registration procedure.

### 4. Embodiments

Next, each embodiment will be described.

### 4.1. First Embodiment

First, a first embodiment will be described. In the present section, the first embodiment may be referred to as the present embodiment.

In the present embodiment, the network may be an onboarding network. Here, the onboarding network may be an SNPN, may be an equivalent SNPN, or may be a PLMN.

In the present embodiment, PLMN selection, and/or SNPN selection, and/or the registration procedure may be performed.

In the present embodiment, a registration procedure for onboarding services may be performed. In the present embodiment, a registration procedure for onboarding services in the SNPN may be performed. Here, performing a registration procedure for onboarding services in the SNPN may mean indicating SNPN onboarding registration in the 5GS registration type information element.

In the present embodiment, a registration procedure for emergency services may be performed.

In the present embodiment, a first control message may be a registration request message.

In the present embodiment, a second control message may be a registration accept message, or may be a registration reject message.

The behaviors of the UE and the network in a case of receiving each control message may be the same as the behaviors of the UE and the network in each procedure described above.

Each step of the present procedure will be described below.

First, the UE transmits the first control message to the network. The UE may transmit the first control message including one or more pieces of identification information out of the first identification information to the second identification information to the network.

Here, the UE may transmit the first control message including one or more pieces of identification information out of the first identification information to the second identification information, and thereby indicate the content indicated by the identification information included in the first control message to the network.

Specifically, the UE may transmit the first identification information, and thereby indicate the 5GS registration type information element to the network. Here, the UE may indicate SNPN onboarding registration in the first identification information. In other words, the UE may indicate SNPN onboarding registration in the 5GS registration type information element to the network. In a case of indicating registration for onboarding services in the SNPN, the UE may transmit the first identification information.

The UE may transmit the second identification information, and thereby indicate that the UE supports the function using the equivalent SNPN, the equivalent SNPN list, or the equivalent SNPN to the network. The UE may transmit the second identification information, and thereby indicate that the UE does not support the function using the equivalent SNPN, the equivalent SNPN list, or the equivalent SNPN to the network. The UE may transmit the second identification information, and thereby indicate whether or not the UE supports the function using the equivalent SNPN, the equivalent SNPN list, or the equivalent SNPN to the network.

Note that the UE may select and determine whether to include one or more pieces of identification information out of the first identification information to the second identification information in the first control message, based on a UE state, each piece of received identification information, and/or the like.

Next, the network receives the first control message from the UE. The network may receive the first control message including one or more pieces of identification information out of the first identification information to the second identification information from the UE.

Furthermore, based on reception of the first control message, the network may store the identification information received together with the first control message, or may recognize determination of the UE. Based on reception of the first control message, the network may recognize the content of the identification information received together with the first control message.

Specifically, in a case of receiving the first identification information, the network may recognize that the UE indicates registration for onboarding services in the SNPN.

In a case of receiving the second identification information, the network may include the 10th identification information in the second control message. In other words, in a case that the UE indicates that the UE supports the function using the equivalent SNPN, the equivalent SNPN list, or the equivalent SNPN in the second identification information, the network may include the 10th identification information in the second control message. In a case that the UE indicates that the UE does not support the function using the equivalent SNPN, the equivalent SNPN list, or the equivalent SNPN in the second identification information, the network need not include the 10th identification information in the second control message.

In a case that the UE indicates registration for onboarding services in the SNPN in the first identification information, the network need not include the 10th identification information in the second control message. In other words, in a case that the UE indicates registration for onboarding services in the SNPN in the first identification information, the network need not include the 10th identification information in the second control message even in a case that the UE indicates that the UE supports the function using the equivalent SNPN, the equivalent SNPN list, or the equivalent SNPN in the second identification information.

In a case that the UE indicates that the UE supports the function using the equivalent SNPN, the equivalent SNPN list, or the equivalent SNPN in the second identification information, the network may determine whether or not to include the 10th identification information in the second control message, depending on whether or not the UE indicates registration for onboarding services in the SNPN in the first identification information.

In a case that the UE indicates that the UE supports the function using the equivalent SNPN, the equivalent SNPN list, or the equivalent SNPN in the second identification information, and the UE does not indicate registration for onboarding services in the SNPN in the first identification information, the network may include the 10th identification information in the second control message.

In a case that the UE indicates that the UE supports the function using the equivalent SNPN, the equivalent SNPN list, or the equivalent SNPN in the second identification information, and the UE indicates registration for onboarding services in the SNPN in the first identification information, the network need not include the 10th identification information in the second control message.

In a case that the UE indicates registration for onboarding services in the SNPN in the first identification information, and the UE indicates that the UE does not support the function using the equivalent SNPN, the equivalent SNPN list, or the equivalent SNPN in the second identification information, the network need not include the 10th identification information in the second control message.

In a case that the UE does not indicate registration for onboarding services in the SNPN in the first identification information, and the UE indicates that the UE does not support the function using the equivalent SNPN, the equivalent SNPN list, or the equivalent SNPN in the second identification information, the network need not include the 10th identification information in the second control message.

Note that the behavior of the network may be performed after receiving the first control message. The behavior of the network may be performed after receiving one or more pieces of identification information out of the first identification information to the second identification information.

In a case of receiving the first control message, the network may perform the behavior in receiving each piece of identification information included in the first control message.

The network may transfer each piece of received identification information to another NF.

Next, the network transmits the second control message to the UE. Here, the network may transmit the second control message including one or more pieces of identification information out of the 10th identification information to the 12th identification information.

Here, the network may transmit the second control message including one or more pieces of identification information out of the 10th identification information to the 12th identification information, and thereby indicate the content indicated by the identification information included in the second control message to the UE.

Specifically, the network may transmit the 10th identification information, and thereby indicate the list of equivalent SNPNs to the UE. The network may transmit the 10th identification information, and thereby indicate a list of available equivalent SNPNs to the UE. The network may transmit the 10th identification information being an empty list, and thereby indicate that available equivalent SNPNs are not present in the UE.

Here, the equivalent SNPN indicated by the 10th identification information may be an equivalent SNPN for the onboarding network. In other words, the equivalent SNPN indicated by the 10th identification information may be one or multiple SNPNs treated the same as the onboarding network.

In a case that the UE indicates registration for onboarding services in the SNPN in the first identification information, the equivalent SNPN indicated by the 10th identification information may be an equivalent SNPN for the onboarding network.

In a case that the UE does not indicate registration for onboarding services in the SNPN in the first identification information, the equivalent SNPN indicated by the 10th identification information may be an equivalent SNPN for a registered SNPN, or may be an equivalent SNPN for an SO-SNPN.

Note that the network may select and determine whether to include one or more pieces of identification information out of the 10th identification information to the 12th identification information in the second control message, based on a UE state, information received from another NF, and/or the like.

The network may determine whether or not to transmit the second control message and/or each piece of identification information, based on a UE state, information received from another NF, and/or the like.

Next, the UE receives the second control message from the network. The UE may receive the second control message including one or more pieces of identification information out of the 10th identification information to the 12th identification information from the network.

Furthermore, based on reception of the second control message, the UE may store the identification information received together with the second control message, or may recognize determination of the network. Based on reception of the second control message, the UE may recognize the content of the identification information received together with the second control message.

Specifically, in a case of receiving the 10th identification information, the UE may store the 10th identification information.

In a case of receiving the 10th identification information, the UE may delete the SNPN IDs in the “temporarily forbidden SNPNs” list or the “permanently forbidden SNPNs” list from the received 10th identification information. In other words, in a case of receiving the 10th identification information, and the registration not being registration for emergency services or registration for onboarding services in the SNPN, the UE may delete the SNPN IDs in the “temporarily forbidden SNPNs” list or the “permanently forbidden SNPNs” list from the received 10th identification information.

In a case of receiving the 10th identification information, the UE may add the SNPN ID of the registered SNPN that has transmitted the 10th identification information to the equivalent SNPN list stored in the UE.

In a case of receiving the 10th identification information, the UE may update the equivalent SNPN list stored in the UE.

In a case of receiving the 10th identification information, and the 10th identification information not including the equivalent SNPN list, the UE may delete the equivalent SNPN list stored in the UE.

In a case of receiving the 10th identification information being an empty list, the UE may recognize that available equivalent SNPNs are not present.

In a case of receiving the 10th identification information, and/or the UE indicating registration for onboarding services in the SNPN in the first identification information, the UE may delete the equivalent SNPN list stored in the UE.

In a case of receiving the 10th identification information, and/or the UE indicating registration for onboarding services in the SNPN in the first identification information, the UE may delete the received 10th identification information.

In a case of receiving the 10th identification information, and/or the UE indicating registration for onboarding services in the SNPN in the first identification information, the UE may ignore the received 10th identification information.

In a case of receiving the 10th identification information, and/or the UE indicating registration for onboarding services in the SNPN in the first identification information, the UE need not update the equivalent SNPN list stored in the UE.

In a case of receiving the 10th identification information, and/or the UE indicating registration for onboarding services in the SNPN in the first identification information, the UE need not add the SNPN ID of the registered SNPN that has transmitted the 10th identification information to the equivalent SNPN list stored in the UE.

Here, the equivalent SNPN indicated by the 10th identification information may be an equivalent SNPN for the onboarding network. In other words, the equivalent SNPN indicated by the 10th identification information may be one or multiple SNPNs treated the same as the onboarding network.

In a case that the UE indicates registration for onboarding services in the SNPN in the first identification information, the equivalent SNPN indicated by the 10th identification information may be an equivalent SNPN for the onboarding network.

In a case that the UE does not indicate registration for onboarding services in the SNPN in the first identification information, the equivalent SNPN indicated by the 10th identification information may be an equivalent SNPN for a registered SNPN, or may be an equivalent SNPN for an SO-SNPN.

In a case that the UE indicates that the UE supports the function using the equivalent SNPN, the equivalent SNPN list, or the equivalent SNPN in the second identification information, and the UE does not receive the 10th identification information, the UE may delete the equivalent SNPN list stored in the UE.

Note that the behavior of the UE may be performed after receiving the second control message. The behavior of the UE may be performed after receiving one or more pieces of identification information out of the 10th identification information to the 12th identification information.

In a case of receiving the second control message, the UE may perform the behavior in a case of receiving each piece of identification information included in the second control message.

In a case of performing SNPN selection again after receiving the second control message, the UE need not select the equivalent SNPN. In other words, in a case of performing SNPN selection again after completion of registration for onboarding services, the UE need not select the equivalent SNPN.

In a case of deleting the equivalent SNPN list stored in the UE, the UE need not select the equivalent SNPN in SNPN selection.

In a case of deleting or ignoring the received 10th identification information, the UE need not select the equivalent SNPN in SNPN selection.

In a case that the UE indicates registration for onboarding services in the SNPN in the first identification information, and the UE does not delete the equivalent SNPN list stored in the UE, the UE need not select the equivalent SNPN in SNPN selection.

In a case that the UE indicates registration for onboarding services in the SNPN in the first identification information, and the UE does not delete or ignore the received 10th identification information, the UE need not select the equivalent SNPN in SNPN selection.

### 4.2. Second Embodiment

Next, a second embodiment will be described. In the present section, the second embodiment may be referred to as the present embodiment.

In the present embodiment, the network may be an SNPN, may be an equivalent SNPN, or may be a PLMN.

In the present embodiment, PLMN selection, and/or SNPN selection, and/or the registration procedure may be performed.

In the present embodiment, a first control message may be a registration request message.

In the present embodiment, a second control message may be a registration accept message, or may be a registration reject message.

The behaviors of the UE and the network in a case of receiving each control message may be the same as the behaviors of the UE and the network in each procedure described above.

Note that, in the present embodiment, the network may not be an onboarding network, or may be an onboarding network. In the present embodiment, the registration procedure for onboarding services may or may not be performed.

Each step of the present procedure will be described below.

First, the UE transmits the first control message to the network. The UE may transmit the first control message including one or more pieces of identification information out of the first identification information to the second identification information to the network.

Here, the UE may transmit the first control message including one or more pieces of identification information out of the first identification information to the second identification information, and thereby indicate the content indicated by the identification information included in the first control message to the network.

Specifically, the UE may transmit the first identification information, and thereby indicate the 5GS registration type information element to the network. Here, the UE may indicate SNPN onboarding registration in the first identification information. In other words, the UE may indicate SNPN onboarding registration in the 5GS registration type information element to the network. In a case of indicating registration for onboarding services in the SNPN, the UE may transmit the first identification information.

The UE may transmit the second identification information, and thereby indicate that the UE supports the function using the equivalent SNPN, the equivalent SNPN list, or the equivalent SNPN to the network. The UE may transmit the second identification information, and thereby indicate that the UE does not support the function using the equivalent SNPN, the equivalent SNPN list, or the equivalent SNPN to the network. The UE may transmit the second identification information, and thereby indicate whether or not the UE supports the function using the equivalent SNPN, the equivalent SNPN list, or the equivalent SNPN to the network.

Note that the UE may select and determine whether to include one or more pieces of identification information out of the first identification information to the second identification information in the first control message, based on a UE state, each piece of received identification information, and/or the like.

Next, the network receives the first control message from the UE. The network may receive the first control message including one or more pieces of identification information out of the first identification information to the second identification information from the UE.

Furthermore, based on reception of the first control message, the network may store the identification information received together with the first control message, or may recognize determination of the UE. Based on reception of the first control message, the network may recognize the content of the identification information received together with the first control message.

Specifically, in a case of receiving the first identification information, the network may recognize that the UE indicates registration for onboarding services in the SNPN.

In a case of receiving the second identification information, the network may include the 10th identification information in the second control message. In other words, in a case that the UE indicates that the UE supports the function using the equivalent SNPN, the equivalent SNPN list, or the equivalent SNPN in the second identification information, the network may include the 10th identification information in the second control message. In a case that the UE indicates that the UE does not support the function using the equivalent SNPN, the equivalent SNPN list, or the equivalent SNPN in the second identification information, the network need not include the 10th identification information in the second control message.

Note that the behavior of the network may be performed after receiving the first control message. The behavior of the network may be performed after receiving one or more pieces of identification information out of the first identification information to the second identification information.

In a case of receiving the first control message, the network may perform the behavior in receiving each piece of identification information included in the first control message.

The network may transfer each piece of received identification information to another NF.

Next, the network transmits the second control message to the UE. Here, the network may transmit the second control message including one or more pieces of identification information out of the 10th identification information to the 12th identification information.

Here, the network may transmit the second control message including one or more pieces of identification information out of the 10th identification information to the 12th identification information, and thereby indicate the content indicated by the identification information included in the second control message to the UE.

Specifically, the network may transmit the 11th identification information, and thereby indicate a reason why registration has been rejected to the UE. The network may transmit the 11th identification information, and thereby indicate a cause value indicating #3 (Illegal UE), #6 (Illegal ME), #7 (5GS services not allowed), #13 (Roaming not allowed in this tracking area), #22 (Congestion), #62 (No network slices available), #74 (Temporarily not authorized for this SNPN), or #75 (Permanently not authorized for this SNPN) to the UE. The network may transmit the 11th identification information, and thereby indicate a cause value other than the above to the UE.

In a case that the network rejects registration of the UE because the UE is an illegal UE, the network may transmit the 11th identification information indicating #3 (Illegal UE) or #6 (Illegal ME). In a case that the network rejects registration of the UE because 5GS services are not allowed, the network may transmit the 11th identification information indicating #7 (5GS services not allowed). In a case that the network rejects registration of the UE because roaming in the tracking area is not allowed, the network may transmit the 11th identification information indicating #13 (Roaming not allowed in this tracking area). In a case that the network rejects registration of the UE because of congestion, the network may transmit the 11th identification information indicating #22 (Congestion). In a case that the network rejects registration of the UE because network slices are unavailable, the network may transmit the 11th identification information indicating #62 (No network slices available). In a case that the network rejects registration of the UE because the SNPN is temporarily not authorized, the network may transmit the 11th identification information indicating #74 (Temporarily not authorized for this SNPN). In a case that the network rejects registration of the UE because the SNPN is permanently not authorized, the network may transmit the 11th identification information indicating #75 (Permanently not authorized for this SNPN).

The network may transmit the 12th identification information, and thereby indicate a cause value indicating that the equivalent SNPN is not allowed to the UE.

In a case that the network rejects registration of the UE because the equivalent SNPN is not allowed, the network may transmit the 12th identification information.

In a case that the network transmits the 11th identification information or the 12th identification information, the network may transmit the 10th identification information being an empty list.

The network may or may not transmit the 10th identification information.

Note that the network may select and determine whether to include one or more pieces of identification information out of the 10th identification information to the 12th identification information in the second control message, based on a UE state, information received from another NF, and/or the like.

The network may determine whether or not to transmit the second control message and/or each piece of identification information, based on a UE state, information received from another NF, and/or the like.

Next, the UE receives the second control message from the network. The UE may receive the second control message including one or more pieces of identification information out of the 10th identification information to the 12th identification information from the network.

Furthermore, based on reception of the second control message, the UE may store the identification information received together with the second control message, or may recognize determination of the network. Based on reception of the second control message, the UE may recognize the content of the identification information received together with the second control message.

Specifically, in a case of receiving the 11th identification information, the UE may delete the equivalent SNPN list stored in the UE.

Furthermore, specifically, in a case of receiving the 11th identification information indicating #3 (Illegal UE), #6 (Illegal ME), #7 (5GS services not allowed), #13 (Roaming not allowed in this tracking area), #22 (Congestion), #62 (No network slices available), #74 (Temporarily not authorized for this SNPN), or #75 (Permanently not authorized for this SNPN), the UE may delete the equivalent SNPN list stored in the UE.

In a case of receiving the 11th identification information indicating a cause value other than the above, the UE may delete the equivalent SNPN list stored in the UE.

In a case of receiving the 12th identification information, the UE may delete the equivalent SNPN list stored in the UE.

In a case of receiving the 11th identification information, and the UE indicating registration for onboarding services in the SNPN in the first identification information, the UE may delete the equivalent SNPN list stored in the UE.

In a case of receiving the 10th identification information being an empty list, the UE may delete the equivalent SNPN list stored in the UE.

After deleting the equivalent SNPN list stored in the UE, the UE may perform SNPN selection or PLMN selection.

Note that the behavior of the UE may be performed after receiving the second control message. The behavior of the UE may be performed after receiving one or more pieces of identification information out of the 10th identification information to the 12th identification information.

In a case of receiving the second control message, the UE may perform the behavior in a case of receiving each piece of identification information included in the second control message.

### 5. Modifications

A program running on an apparatus according to the present example may serve as a program that controls a Central Processing Unit (CPU) and the like to cause a computer to function to realize the functions of the aforementioned embodiments according to the present example. Programs or information handled by the programs are temporarily stored in a volatile memory such as a Random Access Memory (RAM), a non-volatile memory such as a flash memory, a Hard Disk Drive (HDD), or another storage apparatus system.

Note that a program for realizing the functions of the embodiments according to the present example may be recorded on a computer-readable recording medium. The functions may be realized by causing a computer system to read the program recorded on the recording medium for execution. It is assumed that the “computer system” refers to a computer system built into the apparatuses, and the computer system includes an operating system and hardware components such as a peripheral device. In addition, the “computer-readable recording medium” may be a semiconductor recording medium, an optical recording medium, a magnetic recording medium, a medium dynamically retaining the program for a short time, or any other computer-readable recording medium.

In addition, each functional block or various features of the apparatuses used in the aforementioned embodiments may be implemented or performed on an electric circuit, for example, an integrated circuit or multiple integrated circuits. An electric circuit designed to perform the functions described in the present specification may include a general-purpose processor, a digital signal processor (DSP), an application specific integrated circuit (ASIC), a field programmable gate array (FPGA), or other programmable logic devices, discrete gates or transistor logic, discrete hardware components, or a combination thereof. The general-purpose processor may be a microprocessor, or may be a processor of a known type, a controller, a micro-controller, or a state machine instead. The aforementioned electric circuit may include a digital circuit or may include an analog circuit. Furthermore, in a case that with advances in semiconductor technology, a circuit integration technology appears that replaces the present integrated circuits, it is also possible that the present example uses a new integrated circuit based on the technology.

Note that the present example is not limited to the above-described embodiments.

Although apparatuses have been described as an example in the embodiments, the present example is not limited to these apparatuses, and is applicable to a terminal apparatus or a communication apparatus of a fixed-type or a non-stationary electronic apparatus installed indoors or outdoors, for example, an AV apparatus, a kitchen apparatus, a cleaning or washing machine, an air-conditioning apparatus, office equipment, a vending machine, and other household apparatuses.

Although the embodiments of the present example have been described in detail above referring to the drawings, specific configurations are not limited to the embodiments and include, for example, design changes within the scope that do not depart from the gist of the present example. Various modifications are possible within the scope of the present example defined by claims, and embodiments that are made by suitably combining technical means disclosed according to the different embodiments are also included in the technical scope of the present example. In addition, a configuration in which elements described in the respective embodiments and having mutually similar effects are substituted for one another is also included.

### REFERENCE SIGNS LIST

1 Mobile communication system
10 UE_A
30 PGW-U
32 PGW-C
35 SGW
40 MME
45 eNB
50 HSS
60 PCRF
80 Access network_A (E-UTRAN)
90 Core network_A
120 Access network_B (5G AN)
122 gNB
130 UPF
132 SMF
140 AMF
150 UDM
160 PCF
190 Core network_B
235 UPF_A
239 UPF_C

1. A User Equipment (UE) comprising:
transmission and reception circuitry; and
a controller,
wherein
in a case that a first registration request message including information indicating that an equivalent Stand-alone Non-Public Network (SNPN) is supported was transmitted to a first Access and Mobility Management Function (AMF), the transmission and reception circuitry receives a first registration accept message including a first list of equivalent SNPNs from the first AMF,
the controller stores the first list of equivalent SNPNs,
in a case that a second registration request message including information indicating SNPN onboarding registration and the information indicating that the equivalent SNPN is supported was transmitted to a second AMF, the transmission and reception circuitry receives a second registration accept message from the second AMF, and
in a case that the second registration accept message does not include a list of equivalent SNPNs, the controller deletes the stored first list of equivalent SNPNs.

2. (canceled)

3. A communication control method performed by a User Equipment (UE), the communication control method comprising:
in a case that a first registration request message including information indicating that an equivalent Stand-alone Non-Public Network (SNPN) is supported was transmitted to a first Access and Mobility Management Function (AMF), receiving a first registration accept message including a first list of equivalent SNPNs from the first AMF;
storing the first list of equivalent SNPNs;
in a case that a second registration request message including information indicating SNPN onboarding registration and the information indicating that the equivalent SNPN is supported was transmitted to a second AMF, receiving a second registration accept message from the second AMF; and
in a case that the second registration accept message does not include a list of equivalent SNPNs, deleting the stored first list of equivalent SNPNs.
